(19) United States
(12) Patent Application Publication
(10) Pub. No.: US 2021/0097636 A1
(43) Pub. Date: Apr. 1, 2021

(54) Logistics System and Logistics Method

(71) Applicant: Isana Co., Ltd., Gamou-gun, Shiga (JP)

(72) Inventors: Satoshi Oobori, Gamou-gun, Shiga (JP); Tomio Oobori, Gamou-gun, Shiga (JP)

(21) Appl. No.: 16/500,069

(22) PCT Filed: Mar. 27, 2018
(86) PCT No.: PCT/JP2018/012435

§ 371 Date: Oct. 1, 2019

(30) Foreign Application Priority Data
Apr. 6, 2017 (JP) 2017-076227

(51) Int. Cl. G06Q 50/28; G06Q 10/06; G07C 5/00; G06Q 10/04; G06Q 10/02; G06Q 20/04; G06Q 30/02; G06Q 30/00; G06N 20/00; B66F 9/06

(52) U.S. Cl. CPC G06Q 50/28; G06Q 10/06315; G07C 5/008; G06Q 10/047; B66F 9/063; G06Q 20/0457; G06Q 30/0205; G06Q 30/018; G06N 20/00; G06Q 10/02

(57) ABSTRACT

A logistics system comprises: a plurality of base facilities that accept an entry of a transportation device or container which transports pallets, and that carries the pallets in and out, each pallet being provided with pallet identification information; a plurality of base apparatuses that instructs, to the base facilities at each point in time, the pallets to be carried in or out at each base facility; and a logistics control apparatus that decides an planning regarding the distribution of the transportation devices and the pallets. The logistics control apparatus re-decides, regarding the pallets that have been carried into the transportation device or the container, a distribution route for each of the pallets and a base facility to which the transportation device should be routed, and that transmits such determination to the base apparatus of the decided base facility.

### CROSS-REFERENCE TO RELATED APPLICATIONS

This application is the national phase under 35 U.S.C. § 371 of PCT International Application No. PCT/JP2018/012435 which has an International filing date of Mar. 27, 2018 and designated the United States of America.

### FIELD

The present invention relates to a logistics system and a logistics method which are capable of improving a distribution efficiency of articles.

### BACKGROUND

In logistics in Japan, a service in which collected packages arrive at an address of an individual user the next day or during the same day has become normal. Due to the development of a communication environment, the spread of terminal apparatuses, and the improvement in technologies of a material handling system (hereinafter referred to as material handling), a business related to a mail-order sales business is expanding, and a burden of a logistics system that supports the business is excessive.

Various technologies have been proposed to operate logistics efficiently. A system that accurately predicts an arrival time of a carrier vehicle that carries articles to a logistics base including a warehouse for storing articles and controls material handling such that articles to be imported to the carrier vehicle are dispatched from a warehouse without causing the carrier vehicle to wait for a long time, and load assortment is completed is disclosed in Japanese Patent Laid-Open Publication No. 2015-059044.

### SUMMARY

A time-consuming import/export work can be made more efficient by improving an arrival time prediction accuracy. A certain effect can be obtained by improving an article handling efficiency in each logistics base, but it is difficult to achieve a drastic efficiency in logistics with such partial optimization.

Further, when the export of articles to overseas is considered, it is difficult to secure a loading capacity of containers loaded on aircraft or ships at levels of small and medium-sized business operators, agricultural business operators, and single agricultural cooperative, and it has become the neck of the export of articles in units of business operators.

An export mechanism and customs clearance documentation are made more efficient using AI technology, whereas development of the export industry is unable to be expected since there is a physical neck in export by small and medium-sized business operators.

The present invention was made in light of the foregoing, and it is an object of the present invention to provide a logistics system and a logistics method which are capable of drastically improving the efficiency of the logistics mechanism and dramatically improving the distribution efficiency.

A logistics system according to the present disclosure, comprises: a plurality of pallets for logistics assigned with pallet identification information; a plurality of base facilities that accept an entry of a transportation device that transports the pallet or a container loaded on the transportation device, carry the pallet out of the transportation device or the container, carry the pallet in the transportation device or the container, and an exit of the transportation device after the carrying in; a plurality of base servers that instructs, to the base facilities at optional times, a pallet carried out of the transportation device or the container entered the base facilities and a pallet carried in the transportation device or the container; and a central apparatus that decides a distribution route of each pallet and advance planning of a base facility as a waypoint and a destination of the transportation device on the basis of position information of the transportation device and pallet identification information of each pallet. The central apparatus includes a route deciding unit that re-decides the distribution route of each pallet and the base facility as a waypoint and as a destination of the transportation device for a pallet provisionally carried in the transportation device or the container on the basis of the position information of the transportation device at the optional times and the pallet identification information of the pallet and transmits the pallet identification information of a pallet to be carried out of a base server of the decided base facility and a pallet to be carried in the base server of the decided base facility.

In the logistics system according to the present disclosure, the central apparatus instructs, to the transportation device, the base facility of the waypoint or the destination on the basis of a decision result by the route deciding unit after each transportation device starts transportation on the basis of the planning.

In the logistics system according to the present disclosure, the plurality of base facilities may be installed at a distance reciprocally in time corresponding to continuously operable time of the transportation device or corresponding to the maximum daily operating time of the transportation device.

In the logistics system according to the present disclosure, the base facility includes: an carrying-out apparatus that carries out a pallet on which an article is placed of a loading platform of the transportation device or a container loaded on the transportation device; a sorter that sorts and transmits a plurality of pallets including the carried-out pallet; and a carrying-in apparatus that carries in the pallet transmitted from the sorter to the loading platform of the transportation device or the container. The base server receives an instruction including identification information of a transportation device of a carrying-in destination of each pallet or a container loaded on the transportation device based on the distribution route decided by the route deciding unit of the central apparatus, and outputs instruction including a correspondence with the identification information of the pallet to be carried in the loading platform of the transportation device or the container to the sorter and the carrying-in apparatus on the basis of the received instruction.

In the logistics system according to the present disclosure, the transportation device includes a loading platform provided with a frame divided into a plurality of pallet containing parts or contains a container provided with the frame, each pallet containing part of the frame is assigned to containing part identification information. The base server receives instruction including a correspondence of the identification information of the transport device of the carrying-in destination, the pallet identification information of the pallet to be carried in the transport device, and the containing part identification information of the pallet containing part in which each pallet is to be contained. The carrying-in apparatus carries in a pallet in which the identification information included in the instruction is attached to the containing part corresponding to the containing part identification information included in the instruction.

In the logistics system according to the present disclosure, the central apparatus a distribution route indicating one or more base facilities through which a target pallet is to pass on the basis of a dispatching point and a destination point of the target pallet, extracts candidates of a series of containing part identification information in which the containing part identification information of the pallet containing part capable of containing the pallet at the dispatching point is associated with the containing part identification information of the pallet containing parts to pass to the destination point on the basis of the decided distribution route, and accepts sales of a ticket specifying one of the extracted candidates for the target pallet.

In the logistics system according to the present disclosure, the decision of the distribution route is performed by machine learning based on past actual record data.

In the logistics system according to the present disclosure, the central apparatus acquires pallet demand forecasting, acquires an operation plan of the transportation device, and executes an estimation process of estimating the number of tickets available for sales per each time zone for each dispatching point.

In the logistics system according to the present disclosure, the demand forecasting or the estimation process is performed by machine learning based on the past actual record data.

A logistics system according to the present disclosure, comprises: a plurality of pallets for logistics assigned with pallet identification information; a plurality of transportation devices including a loading platform or a container provided with a frame divided into a plurality of pallet containing parts; a plurality of base facilities that accept entries and exits of the plurality of transportation devices; a plurality of base servers that output instruction instructing a pallet to be carried out of the loading platform or the container frame of the transportation device to be loaded in the plurality of base facilities and a pallet to be carried in the frame to the base facilities; and a central apparatus that is communication-connected with the plurality of base servers and decides a distribution route of each pallet, the base facilities as a waypoint or a destination of the transportation device on the basis of position information of the transportation device, the containing part identification information assigned to each pallet containing part of the frame of the transportation device, and the pallet identification information. The central apparatus transmits, to the plurality of base servers, containing part identification information of a pallet containing part in which a pallet to be carried out of the transportation device entered each of the plurality of base facilities and instruction including a correspondence of pallet identification information of a pallet to be carried in the transportation device and containing part identification information of a pallet containing part in which the pallet to be contained. In the plurality of base facilities, on the basis of the containing part identification information, in which the pallet to be carried out is contained, included in the instruction output by the corresponding base server, the pallet is carried out of the pallet containing part of the transportation device to be loaded or the container, and a pallet to which the corresponding pallet identification information is assigned is carried in the pallet containing part corresponding to the containing part identification information included in the instruction.

A logistics system according to the present disclosure, comprises: a plurality of pallets for logistics assigned with pallet identification information; a plurality of base facilities that accept an entry of a transportation device that transports a pallet or a container, the transportation device including a loading platform provided with a frame capable of containing a plurality of pallets is installed, carry the pallet out of the loading platform or the container, carry the pallet in the loading platform or the container, and an exit the transportation device or the container after the carrying in; a plurality of base servers that instruct the pallet to be carried out and the pallet to be carried in the base facilities; and a central apparatus that is communication-connected with the plurality of base servers and decides a distribution route of each pallet, a base facility through which the transportation device is to pass, and a destination base facility on the basis of position information of the transportation device and the pallet identification information of the pallet. Each of the base facilities includes an carrying-out apparatus that carries out a pallet on which an carrying-out apparatus that carries out a pallet on which an article is placed of a loading platform of the transportation device or a container loaded on the transportation device, a sorter that sorts and transmits a plurality of pallets including the carried-out pallet, and a carrying-in apparatus that carries in the pallet transmitted from the sorter to the loading platform or the container. Containing part identification information is assigned with each pallet containing part of the frame of the loading platform of the transportation device or the container loaded on the transportation device. The base server receives instruction including a correspondence of identification information of a loading platform of a transportation device of a carrying-in destination of each pallet or a container loaded on the transportation device based on the distribution route decided by the central apparatus, pallet identification information of a pallet to be carried in the loading platform of the transportation device or the container, and containing part identification information of a containing part in which each pallet is to be contained, and outputs instruction including a correspondence of the pallet identification information of the pallet to be carried in the loading platform of the transportation device or the container loaded on the transportation device and containing part identification information to the sorter and the carrying-in apparatus on the basis of the received instruction. The carrying-in apparatus carries in a pallet in which the identification information included in the instruction is attached to the containing part corresponding to the containing part identification information included in the instruction.

A logistics method according to the present disclosure, using a plurality of logistics pallets and a transportation device that transports the plurality of pallets, wherein a central apparatus that decides a transportation route of the transportation device that transports the pallet and advance planning of a distribution route of each pallet and a base server that instructs, to the base facilities, a pallet to be carried out and a pallet to be carried in, corresponding to a plurality of base facilities that are installed at a distance of a transportation route shape of the transportation device are used, comprises: acquiring, by the central apparatus, position information of the transportation device at each time; storing, by the central apparatus, pallet identification information attached to each of the plurality of pallets in association with device identification information assigned with each of the transportation devices that transport the pallet; re-deciding, by the central apparatus, the distribution route of each pallet and the base facility as waypoint and a destination for a pallet provisionally carried in the transportation device on the basis of the position information of the transportation device at optional times and the pallet identification information of the pallet; transmitting, by the central apparatus, device identification information of the transportation device heading for the corresponding base facility and the pallet identification information of a pallet to be carried out of the transportation device and a pallet to be carried in the transportation device to the base server of the decided base facility; and instructing the base facility to pass to the transportation device.

In the logistics system of the present disclosure, it is possible to optimize movement of articles and movement of the transportation devices while considering the distribution routes that extend beyond a framework of each region and reach the entire country and even international distribution routes.

In the logistics system of the present disclosure, even after the transportation device starts the transportation on the basis of the advance planning, the appropriate distribution of the transportation device modified in accordance with the change in the situation such as the accepted package or the traffic situation in the transportation route and the distribution route of each pallet are reflected at the time of carrying them out of the base center and carrying them in the base center.

In the logistics system of the present disclosure, it is also possible to achieve returning to the departure point within 24 hours within the regulations of driving work such as the maximum driving time per day under the condition that at least one base facility exists in each prefecture.

In the logistics system of the present disclosure, carrying the articles out of the transportation device or the container in the base facility in units of pallets and carrying the articles in the transportation device or the container are performed by the carrying-out apparatus and the carrying-in apparatus, and the operation by the operator is not necessary. Accordingly, it is possible to solve a safety problem of a lifting work at a branch point (cross docking). If the operation of the transportation device can also be performed automatically, it is possible to aim for efficient transportation throughout the distribution route.

In the logistics system of the present disclosure, the placement of each pallet on the loading platform of the transportation device is also made so that they are identifiable from each other within the frame to which the identification information is attached, and thus it is possible to specify which position of which transportation device the article is contained at. Since the location of the distribution target article is clarified during distribution, it is possible to carry it in and out automatically, only some pallets can be replaced in the base facility, and sharing of the loading platform or the container can be easily realized. Accordingly, in addition to the distribution efficient, the traceability is also improved.

In the logistics system of the present disclosure, it is possible to share the loading platform or the container in units of pallet containing parts. A route which the pallet follows before reaching the destination can be described in association with units of pallet containing parts instead of units of transportation devices. The sale of the logistics ticket can be accepted in units of pallet containing parts, and sharing of the platform or the container becomes more realistic. With the ticket system in which an agricultural business operator or a small and medium-sized business operator can share the container in units of pallet containing parts and purchase them as a single unit, it is possible to export an amount which is as twice large as the related art by loading products or processed products on the pallet, and it is possible to export at a low cost. As described above, with the ticket sales, choices of the consignors and the transport business operators increases, and reduction in a work time, reduction in an execution costs, and improvement in energy efficiency are expected.

Further, it is possible to achieve the distribution (relay) route decision, the pallet demand forecasting, or the process of estimating the number of tickets available for sales further efficiently by a technique of obtaining them by learning based on the neural network.

The logistics system of the present disclosure can drastically improve the logistics mechanism and dramatically improve distribution efficiency.

### BRIEF DESCRIPTION OF THE DRAWINGS

FIG. 1 is a schematic diagram illustrating an overview of a logistics system of the present disclosure.

FIG. 2 is a block diagram schematically illustrating a configuration of a logistics system in the present embodiment.

FIG. 3A is an explanatory diagram schematically illustrating a pallet containing part.

FIG. 3B is an explanatory diagram schematically illustrating a pallet containing part.

FIG. 3C is an explanatory diagram schematically illustrating a pallet containing part.

FIG. 4 is an enlarged view illustrating a folding mechanism of a pallet frame.

FIG. 5 is a schematic diagram of a pallet.

FIG. 6 is a schematic top view illustrating an export apparatus included in a material handling system of a base center.

FIG. 7 is a schematic top view illustrating a carrying-in apparatus included in a material handling system of a base center.

FIG. 8 is a block diagram illustrating configurations of a base server and a material handling system in a base center.

FIG. 9 is a block diagram illustrating configurations of an collecting site server and an inspecting apparatus in an collecting center.

FIG. 10 is a block diagram illustrating a configuration of a central server.

FIG. 11 is a flowchart illustrating an example of a processing procedure in an collecting site server.

FIG. 12 is a flowchart illustrating an example of a first processing procedure in a base server.

FIG. 13 is a flowchart illustrating an example of a second processing procedure (export) in a base server.

FIG. 14 is a flowchart illustrating an example of a third processing procedure (import) in a base server.

FIG. 15 is a functional block diagram illustrating an overview of a process in a central server.

FIG. 16 is a flowchart illustrating an example of a processing procedure by a control unit of a central server.

FIG. 17 is a flowchart illustrating an example of a processing procedure by a control unit of a central server.

FIG. 18 is a flowchart illustrating an example of a procedure of a process of deciding a pallet distribution route and a transport device transportation route.

FIG. 19 is a diagram illustrating a content example of an interface provided by a central server.

FIG. 20 is a flowchart illustrating an example of a ticket sales acceptance procedure for transportation in a logistics system.

FIG. 21 is a functional block diagram related to optimization of demand forecasting and distribution route in a central server.

FIG. 22 is a flowchart illustrating an example of a processing procedure of demand forecasting NN generation in a first learning unit.

FIG. 23 is a flowchart illustrating an example of a processing procedure of distribution route optimization NN generation by a second learning unit.

FIG. 24 is a schematic diagram illustrating an optimization process of an operation plan.

FIG. 25 is a flowchart illustrating an example of a processing procedure by a control unit of a central server.

FIG. 26 is a flowchart illustrating an example of a processing procedure by a control unit of a central server.

FIG. 27 is a flowchart illustrating an example of a decision processing procedure of a distribution route.

### DETAILED DESCRIPTION

Hereinafter, a logistics system according to the present invention will be described with reference to the drawings illustrating embodiments. In the following example, the distribution of crops will be described as an example, but of course, a transport target in the logistics system is not limited to crops.

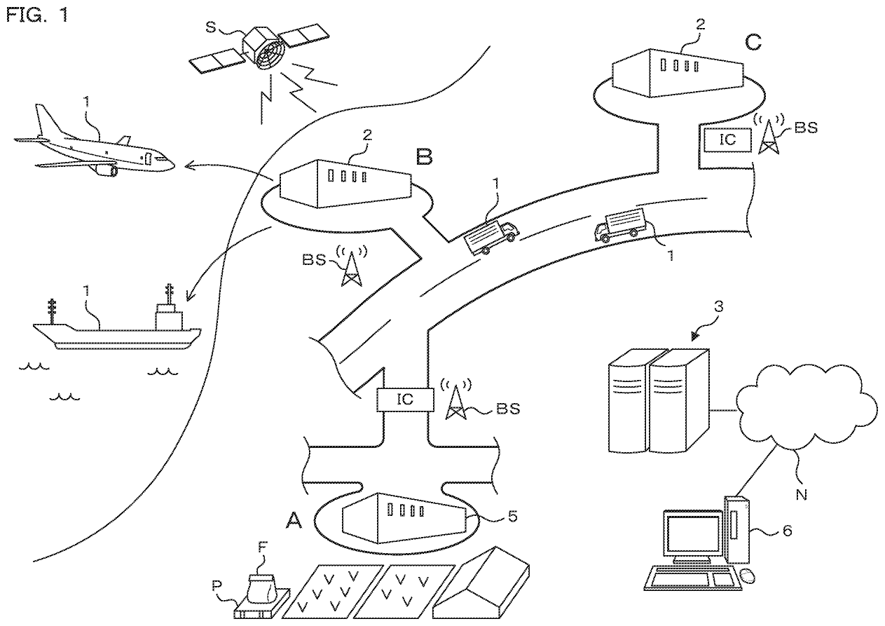

FIG. 1 is an explanatory diagram illustrating an overview of a logistics system 100 in the present embodiment. The logistics system 100 includes a transportation device 1 and a plurality of base centers 2 that can be accessed by the transportation device 1 while traveling. The transportation device 1 is a vehicle such as a transportation truck, train, a transport aircraft, or a ship. The base center 2 is preferably installed at a place serving as a base of the transportation device 1 such as a port, an airport, a freight station, or an interchange (IC) in a road network as illustrated in FIG. 1. The logistics system 100 further includes an collecting center 5 in which pallets P on which an article (for example, a crop F in FIG. 1) is placed are collected. The collecting center 5 may double as the base center 2. One or more base centers 2 are installed in accordance with a size of a port, an airport, a freight station, or an administrative division in a road network from which international delivery arrive and depart. The collecting center 5 may be installed in each of regions divided to be larger in number than the administrative divisions (which may cross the division).

In a case in which the logistics system 100 uses a road network, in the example in FIG. 1, the collecting center 5 (also used as base center 2) installed in an A prefecture, the base center 2 installed in a B prefecture, and the base center 2 installed in a C prefecture are included. A distance between the adjacent base centers 2 and 2 is set to be a distance at which the transportation device 1 which is a transportation truck can make one round trip within one working day of a driver even though it is long. In the example illustrated in FIG. 1, the distance from the collecting center 5 doubling as the base center 2 in the A prefecture to the base center 2 in the C prefecture is approximately 300 kilometers, which is the distance at which the driver can reciprocate twice within one working day. The base center 2 in the B prefecture is located between the collecting center 5 in the A prefecture and base center 2 in the C prefecture.

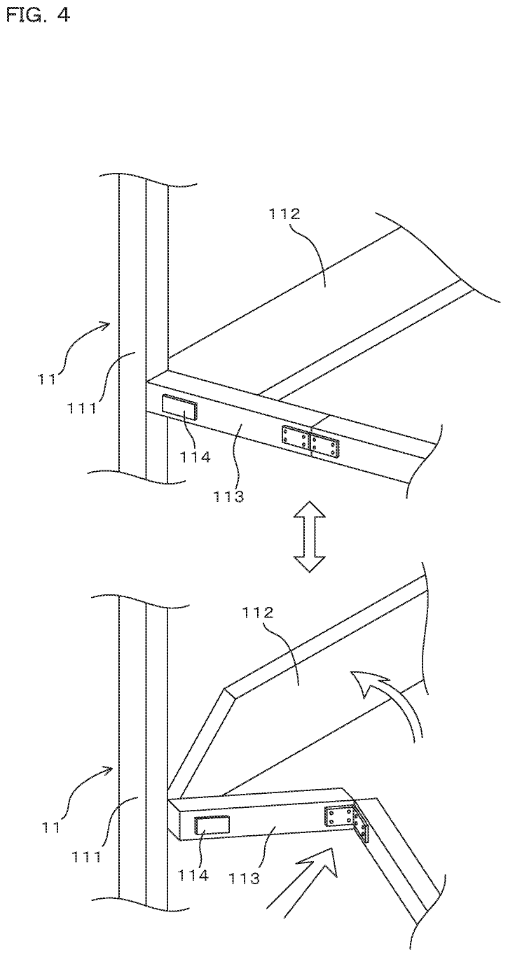

In the logistics system 100 of the present disclosure, all articles to be transported are transported in units of the pallets P. In the example of FIG. 1, the crops F are placed on the same pallet P. Different crops F may be mixed within the same pallet P, and articles in which the base centers 2 (administrative division) corresponding to locations of respective consignees are the same are placed. The pallet P is an existing logistics member with dimensions of 90 cm×90 cm, and it is desirable that it be made of a material which is not subject to export/import regulations. The pallet P includes a tag PT (see FIG. 4) using a two-dimensional bar code having unique pallet identification information stored therein or a radio tag such as a radio frequency identifier (RFID).

In the collecting center 5, a work of placing the crops F collected from respective producers on the pallet P is performed in accordance with the destination of the consignee. The work of placing them on the pallet P may be performed at the workplace of the producer. The collecting center 5 is operated by an organization to which many producers belong such as an agricultural cooperative. In the collecting center 5, the work of placing the crops F brought from the producers in associated areas or collected by the organization is performed collectively. An entity of performing the placement work in the collecting center 5 may be a worker who is a person belonging to the organization, or the placement work may be automated by material handling and robots incorporated in material handling.

The pallet P on which the crops F to be transported are placed in the collecting center 5 is transported to the corresponding base center 2. Since the transport between the collecting center 5 and the base center 2 is an intra-district distribution, a specific transport method is not limited except that it is the transport in units of the pallets P.

The base center 2 accepts an entry and an exit of the transportation device 1 used in the logistics system 100 of the present disclosure, and carries the articles in units of the pallets P out of the transportation device 1 that has been warehoused and carries the articles in the empty space in units of the pallets P. In the case of a large-scale transportation device 1 such as a transport aircraft, carrying-in and out are performed in units of containers C in which the pallets P are contained. The carrying-in/out works is preferably realized by the material handling as will be described later, and thus the need for works by forklift operators is eliminated.

Further, the transportation device 1 exited from the base center 2 acquires position information using information from global positioning system (GPS) satellites S by an on-board communication device (for example, a navigation system in the case of a vehicle) or a mobile terminal apparatus carried by the driver. The acquired position information is sequentially transmitted from the transportation device 1 to a central server 3 (logistic control apparatus) via a network N. On the basis of the latest position information associated with device identification information of each transportation device 1 and pallet identification information of the pallet P in the transportation device 1, the central server 3 gives an instruction instructing a base center 2 toward which it is to go to the communication device or mobile terminal apparatus through an optimization process to be described later.

The transportation device 1 heads to the base center 2 as instructed from the central server 3, is entered, and carries in and out the articles in units of pallets P or in units of the containers C containing the pallets P, and heads to the next base center 2.

In a case in which the transportation device 1 is a transportation truck, the next base center 2 instructed to the transportation device 1 from the central server 3 is a base center 2 installed within a range in which the transportation device 1 which is a transportation truck can return to the departure point of the day within the day. For example, the central server 3 gives an instruction instructing the base center 2 in the B prefecture or the base center 2 in the C prefecture to the transportation device 1 exited from the collecting center 5 (the base center 2) in the A prefecture. The transportation device 1 instructed to go to the base center 2 in the B prefecture receives an instruction to return to the base center 2 in the A prefecture or to head to the base center 2 in the C prefecture from the central server 3 after carrying in and out. The transportation device 1 returned to the base center 2 in the A prefecture ends an operation of one day as it is after carrying out or heads to the base center 2 in the A prefecture again or the base center 2 in other neighboring prefectures after carrying out. The transportation truck 1 heading to the base center 2 in the C prefecture receives an instruction to return directly to the base center 2 in the A prefecture after carrying in and out or receives an instruction to return the base center 2 in the A prefecture via the base center 2 in the B prefecture. The transportation device 1 carries in and outs the articles even at the base center 2 in the B prefecture which is the transit point.

As described above, in the logistics system 100 of the present embodiment, the transportation device 1 which is a transportation truck need not go farther than the distance that can be reciprocated in one day. In a case in which the transportation device 1 is a transport aircraft, a ship, or a train, a period is longer than one day, but it is desirable that it be considered to be the same. For example, in a case in which the crops F are transported from Kagoshima prefecture (A prefecture) to Osaka prefecture (C prefecture), the transportation device 1, which is the transportation truck that has carried in the target pallet P at the base center 2, is not operated directly from Kagoshima prefecture to Osaka prefecture and carries out the pallets P in the base center 2 such as Kumamoto prefecture or Fukuoka prefecture on the way which is at a distance of about 300 to 400 km. Then, the transportation device 1 which is the transportation truck carries in the pallets P in the other Kagoshima prefectures and returns to Kagoshima prefecture. The transportation device 1, which is another transportation truck that has carried in the target pallet P at the base center 2 in Kumamoto prefecture or Fukuoka prefecture, drops off them again at the base center 2 in Yamaguchi prefecture or Hiroshima prefecture which is at a distance of about 300 to 400 km. In other words, each base center 2 plays a role of a branch point in cross docking. The transportation device 1 which is another transportation truck which has dropped the other pallets P at the base center 2 in Yamaguchi prefecture or Hiroshima prefecture carries in the target pallets P, heads to the base center 2 in Osaka prefecture, and drops off the target pallets P there. In other words, all the drivers of the transportation devices 1 which are transportation trucks can return to the departure point within the day. Accordingly, although time zones for driving duties are various, it is possible to avoid a working environment in which the drivers can return to home only two days a week.

In the above example, according to such a logistics system 100, for example, the target pallet P is dropped off at the base center 2 in Fukuoka prefecture (the B prefecture) before noon around 12 O'clock by the transportation device 1 which is a transportation truck that has departed Kagoshima prefecture (A prefecture) at 8:00 a.m. The target pallet P is entered in the base center 2 in Fukuoka prefecture at about 13:00 and then carried in the transportation device 1 heading to the base center 2 in Hiroshima prefecture via the road network. For example, the target pallet P is carried out at 16:30 p.m. at the base center 2 in Hiroshima prefecture and carried in the transportation device 1 heading from the base center 2 in Hiroshima prefecture to the base center 2 in Hiroshima prefecture (C prefecture) via the road network around 17:00. Accordingly, it arrives at the base center 2 in Osaka prefecture after 20:00 and it is transported to the collecting center 5 in Osaka prefecture, and thus the articles in the target pallet P can be transported to the consignee the next day. If there are a sufficient number of transportation devices 1, rapid distribution can be performed. In order to realize a sufficient number of transportation devices 1, since the transportation truck 1 of one operator is, of course, insufficient, it is necessary to make up for it through a contract between the entire logistics system 100 and each of the transportation devices 1 other than a lease contract between a collection/distribution business operator and the transportation device 1.

Further, the user of the logistics system 100 that realizes the transportation of the articles by using the transportation device 1 uses an information processing apparatus 6 for displaying or operating an interface provided by the central server 3.

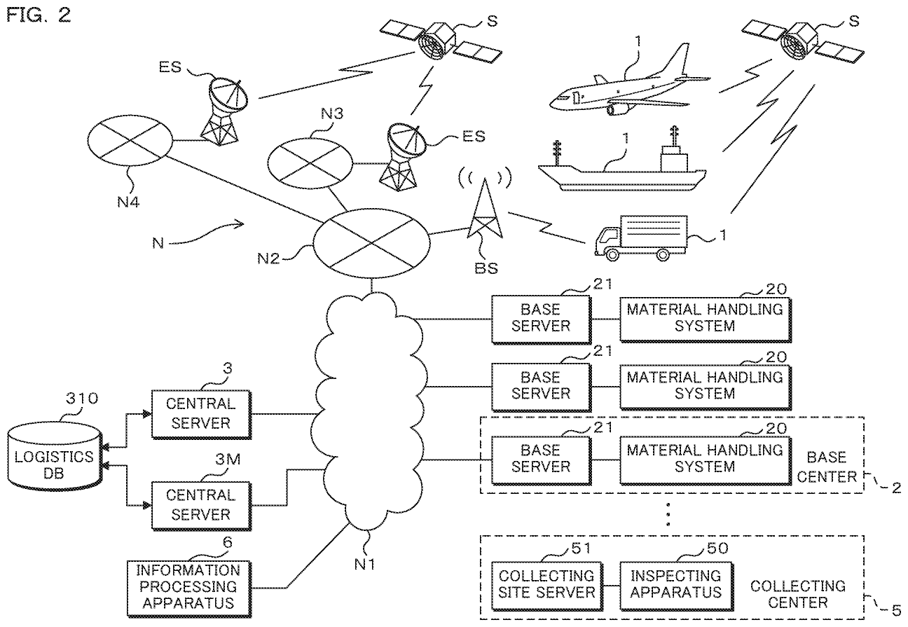

FIG. 2 is a block diagram schematically illustrating a configuration of the logistics system 100 in the present embodiment. A material handling system 20 that automatically the carrying-in and out and a base server (base apparatus) 21 that controls the material handling system 20 and processes information of the pallet P and the like are installed in each base center 2. An collecting site server 51 and an inspecting apparatus 50 are installed in the collecting center 5. The base server 21 and the collecting site server 51 can be connected to the central server 3 via the network N.

The network N includes a public communication network N1 which is a so-called Internet, a carrier network N2 that realizes radio communication in accordance with a predetermined communication standard on the ground, a communication network N3 that realizes maritime communication, and a communication network N4 that realizes aeronautical communication. The carrier network N2 that realizes radio communication on the ground includes a base station BS, and an in-vehicle device of the transportation device 1 which is a transportation truck, a train, or the like or the mobile terminal apparatus carried by the driver (passenger) can perform communication with other apparatus from the base station BS via the network N. Each of the communication networks N3 and N4 includes a radio station ES such as a ship earth station or an aviation earth station installed on the ground.

A central server 3M that operates as a mirror for compensation is preferably prepared as the central server 3. The central server 3 and the central server 3M can record information in a logistics DB 310 and read information from the logistics DB 310. An operation of the central server 3 and the logistics DB 310 will be described later in detail.

The information processing apparatus 6 is a computer which is used by the user who uses the logistics system 100 and is an apparatus including a communication unit and a user interface that realizes communication via the network N. The information processing apparatus 6 is a desktop or laptop personal computer, a tablet terminal, a smart phone, or the like.

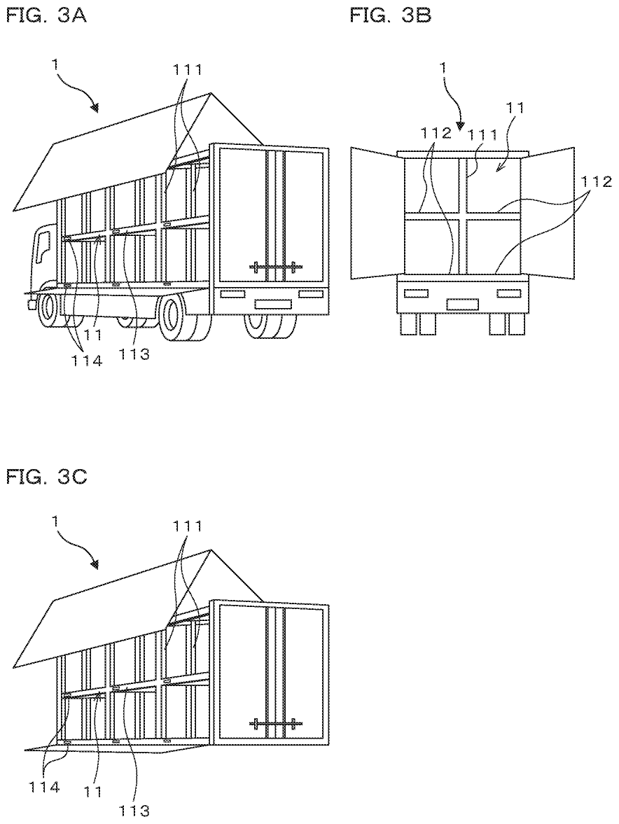

FIGS. 3A-3C are an explanatory diagram schematically illustrating a pallet containing part. FIG. 3A is a schematic perspective view of the pallet containing part in the transportation device 1 which is a transportation truck, and FIG. 3B is a schematic view of the transportation truck in FIG. 3A when viewed from the rear. The transportation device 1, which is a transportation truck, includes a pallet frame 11 which is installed in a loading platform in order to transport the articles in units of the pallets P. The pallet frame 11 is a multi-stage shelf that can contain a plurality of pallets P. In FIG. 3, the multi-stage shelf has two stages but is not limited thereto. The pallet frame 11 includes a plurality of props 111 having a height from a floor surface to a ceiling of the loading platform, a beam connecting the upper parts of the props 111 in a vehicle length direction and a vehicle width direction, a load receiving plate 112 that connects and the central parts of the props 111 in the vehicle width direction, and a lateral frame 113 that connects the central parts of the props 111 in the vehicle length direction. For example, it is assumed that the transportation device 1 which is a transportation truck is a 10-tons truck, and the loading platform has a size of 235 cm in the vehicle width direction, 960 cm in the vehicle length direction, and 235 cm in the vehicle height direction. In this case, it has two rows in the vehicle width direction, five rows in the vehicle length direction, and two stages in the vehicle height direction, and thus a total of 20 pallet Ps can be contained. Further, a tag 114 that stores unique containing part identification information in the transportation truck is attached to the lateral frame 113 of each pallet containing part of the pallet frame 11. The tag 114 may be one having only numbers or letters attached thereto, may be a one-dimensional barcode or a two-dimensional barcode, or may be a radio tag such as an RFID. It is possible to identify all pallet containing parts in the logistics system 100 by a combination of vehicle identification information (either or both of a vehicle number (license plate) and identification information of an in-vehicle device) identifying each transportation device which is a transportation truck and containing part identification information of the pallet containing part attached to each pallet containing part in the vehicle.

FIG. 3C is a schematic perspective view of the containing part of the pallet P in the container C contained in the transportation device 1 which is an aircraft, a ship, or a train. In the transportation device 1 which is an aircraft, a ship, or a train, the container C in which the pallet frame 11 is installed thereinside is used to transport the articles in units of the pallets P. As described above, each pallet frame 11 includes a pallet containing part to which the tag 114 storing the containing part identification information is attached. A tag 114 that stores container identification information is preferably attached to the container C. It is possible to specify each of all the pallet containing parts in the logistics system 100 by a combination of aircraft identification information identifying each transportation device 1 which is a transport aircraft (aircraft), ship identification information identifying each transportation device 1 which is a ship, container identification information of the container C carried in the transportation device 1, and the containing part identification information attached to each pallet containing part in the container C. In the case of a train, it is possible to specify it by a combination of vehicle identification information identifying a composition (a towing vehicle or a locomotive), the container identification information of the container C, and the containing part identification information of each pallet containing part in the container C. Further, it is possible to detect position information of all the pallet containing parts in the central server 3 using the position information of the transportation device 1.

It is desirable that the pallet frame 11 installed in the loading platform of the transportation device 1 or the container C be foldable. FIG. 4 is an enlarged view illustrating a folding mechanism of the pallet frame 11. For example, each prop 111 is movable back and forth along a rail installed along a length direction on the loading platform of the transportation truck bed or the floor of the container C, and the lateral frame in the length direction is foldable toward the inner side of the loading platform one or more times as indicated in a lower part of FIG. 4. At this time, the load receiving plate 112 can be flipped upward. According, the pallet frame 11 can be compacted at the front of the loading platform since it is foldable, and thus the loading platform or the container C can be used for, for example, other purposes for carrying articles larger than pallet P.

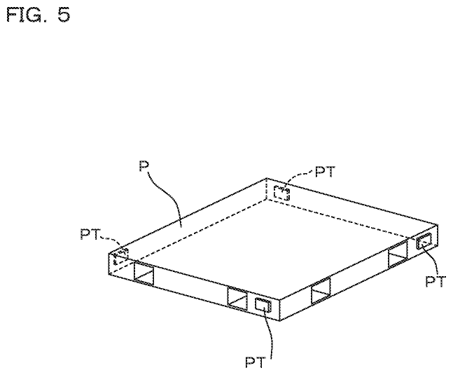

FIG. 5 is a schematic diagram of the pallet P. The pallet P is a logistics member with a size of 90 cm in four directions, similarly to the pallet widely used in the logistics field and may be made of various materials such as resin, wood, stainless steel, and corrugated ball and includes lift holes suitable for transportation by forklifts. As the pallet P in the present embodiment, a pallet made of a material conforming to import/export regulations is used. A tag PT storing the same pallet identification information in all four directions is attached to all sides of the pallet P. Although it may be attached to only one surface, it is attached to four directions not to limit an orientation of the pallet P which is symmetrical in four directions. The tag PT is a predetermined medium on which a one-dimensional bar code or a two-dimensional bar code corresponding to the pallet identification information of the pallet P assigned in advance is printed. Further, the tag PT is a radio tag using an RFID or the like, and the pallet identification information of the pallet P assigned in advance is stored to be readable by a wireless reader. Although the pallet identification information of the pallet P in the radio tag is unable to be rewritten, information of one or more articles placed on the pallet P may be able to be written in the radio tag by a wireless writer. The information of the article includes a type and item of an article, a weight, a date of collection, an article delivery number, base identification information of the base center 2 which has passed through most recently, a destination base center 2, consignee information, sender information, and the like.

Since there is a problem of distribution of the pallet P itself as will be described later, the pallet P is not limited to a pallet having the thickness illustrated in FIG. 5 and may be a sheet-like pallet having made of paper or resin in which a cardboard or the like is enhanced. In this case, the sheet-like pallet P is placed on a pallet having a lift hole as illustrated in FIG. 5 and used, and only the sheet-like pallet P is carried in or out from the loading platform of the transportation device 1 or the container C.

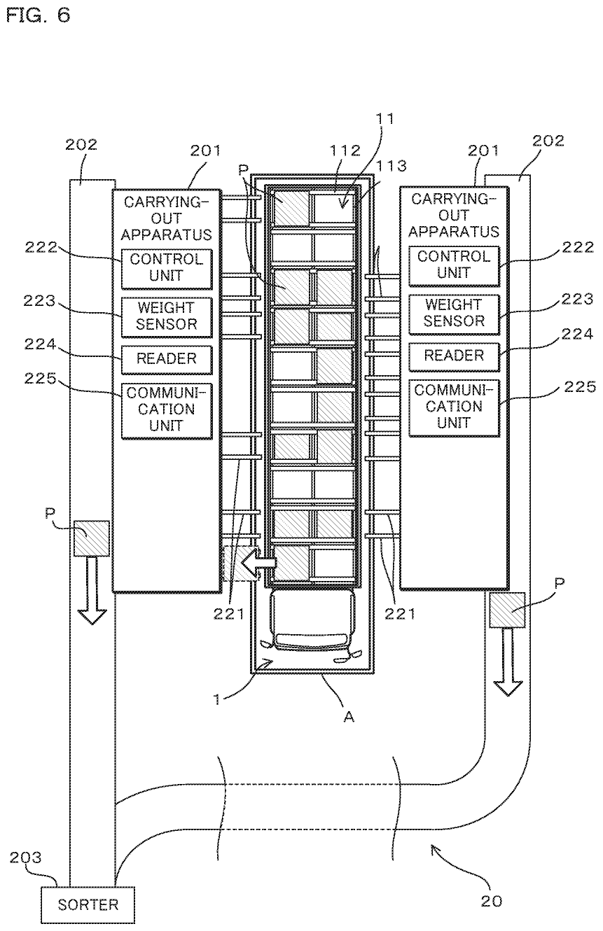

Next, the carrying-in and out of the pallet P illustrated in FIG. 5 using the transportation device 1 installed with the pallet frame 11 of FIG. 4 will be described. FIG. 6 is a schematic top view illustrating the carrying-out apparatus 201 included in the material handling system 20 of the base center 2. Although FIG. 6 shows an example in which a transportation truck is used as the transportation device 1, carrying-out can be performed, by an operation similar to the carrying-out from the transportation truck, by using a transport mechanism (a conveyor, a vehicle, or a transport robot) that transports the container C.

The carrying-out apparatus 201 includes a carrying-out arm 221, a control unit 222, a weight sensor 223, a reader 224, and a communication unit 225. The carrying-out apparatus 201 includes an carrying-out mechanism including the carrying-out arms 221 which are arranged in parallel with a length corresponding to the maximum length of the transportation device 1 along both long sides of a rectangular stop range A which is a range in which the transportation device 1 receiving the carrying-out stops. The carrying-out arm 221 is installed in a direction along a short direction of the stop range A and can be moved by a stroke length of a cylinder in the short direction in accordance with an operation of the cylinder based on the control of the control unit 222. A parallel arrangement interval of the carrying-out arms 221 corresponds to an interval of forklift holes in the pallet P when the pallet P is placed on the pallet frame 11. The number of carrying-out arms 221 may not correspond to the number of all the pallet containing parts of the pallet frame 11 as illustrated in FIG. 6. The carrying-out arms 221 which are smaller in number than the pallet containing parts may be installed, for example, only one carrying-out arms 221 may be installed or one carrying-out arms 221 may be installed in each stage, and the carrying-out arms 221 may be configured to move to be able to correspond to any one pallet containing part.

A control circuit such as a programmable logic controller (PLC) or a processor such as a central processing unit (CPU) is used as the control unit 222, and the control unit 222 controls the components of the carrying-out apparatus 201. The control unit 222 detects that the transportation device 1 is entered and stops within the stop range A. At this time, the control unit 222 may acquire vehicle identification information (container identification information) of the stopped the transportation device 1. If the control unit 222 detects the stop of the loading platform of the transportation device 1 (or the container C), the control unit 222 performs control such that the cylinder of the carrying-out arm 221 corresponding to the pallet containing part in which the pallet P is placed among the respective pallet containing parts of the pallet frame 11 of the loading platform of the transportation device 1 (the container C) stopped within the stop range A operates. In the carrying-out apparatus 201, the control unit 222 may be configured such that the cylinder of the carrying-out arm 221 operates on all pallet containing parts of the pallet frame 11 of the loading platform of the transportation device 1 (the container C) that has been entering. Since the pallet frame 11 has two stages, the carrying-out arm 221 may perform the operation of carrying out it by one stage at a time.

The weight sensor 223 receives the pallet P carried out by the carrying-out arm 221 and measures the weight of the pallet P. The weight sensor 223 may be incorporated into the carrying-out arm 221. The reader 224 is attached as a set with the weight sensor 223 and reads the pallet identification information of the pallet P extracted by the carrying-out arm 221 from the tag PT. The reader 224 may be a reader such as an RFID or may be a device that reads the pallet identification information by image processing when the tag PT is a two-dimensional barcode. The communication unit 225 is a communication device that realizes a communication connection with the base server 21 in the base center 2 in a wireless or wired manner. The control unit 222 of the carrying-out apparatus 201 receives an instruction from the base server 21 through the communication unit 225 and controls the carrying-out arm 221 such that the pallet identification information of each pallet P carried out by the carrying-out arm 221 and the weight of the pallet P at the time of carrying-out are transmitted from the communication unit 225 to the base server 21 in association with each other.

The carrying-out apparatus 201 is connected to a line 202 that constitutes the material handling system 20. The line 202 is a belt conveyor that transports the carried-out pallet P to a sorter 203 one by one.

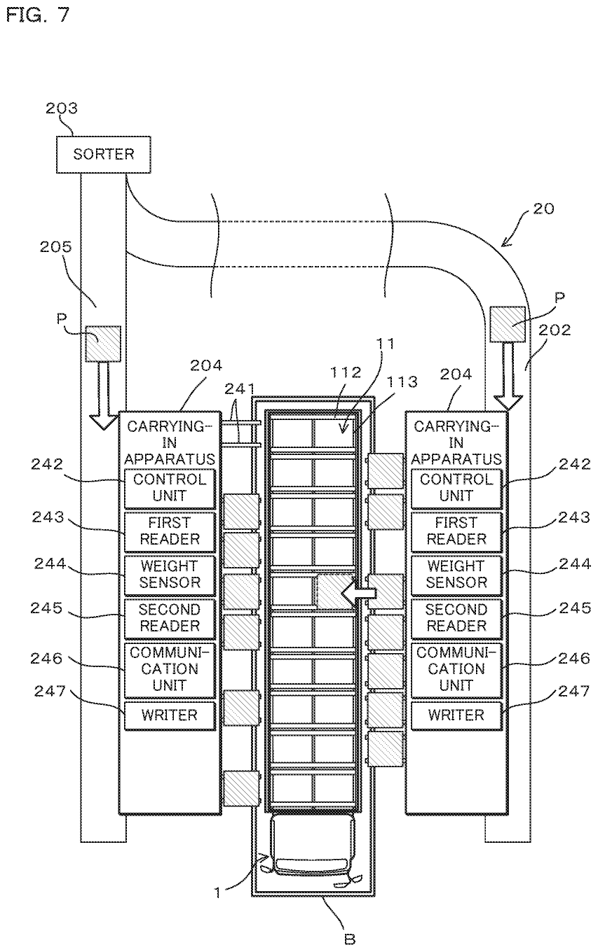

The sorter 203 receives an instruction from the base server 21 and places the pallet P on a buffer rack or the like, sorts it on the basis of each piece of pallet identification information, and transmits it to a line 205 on a carrying-in apparatus 204 side. The pallets P sorted by the sorter 203 includes not only the pallet P transported from the transportation device 1 (the container C) by the carrying-out apparatus 201 but also from the pallet P transported from the collecting center 5 to the base center 2 through a transportation means other than the transportation device 1 (the container C). The line 205 is connected to the carrying-in apparatus 204. FIG. 7 is a schematic top view illustrating the carrying-in apparatus 204 included in the material handling system 20 of the base center 2.

The carrying-in apparatus 204 includes a carrying-in arm 241, a control unit 242, a first reader 243, a weight sensor 244, a second reader 245, a communication unit 246, and a writer 247. The carrying-in apparatus 204 includes a carrying-in mechanism in which carrying-in arms 241 are arranged in parallel with a length corresponding to the maximum length of the transportation device 1 along both long sides of a rectangular stop range B which is a range in which the transportation device 1 (or the container C) receiving the carrying-in stops. The carrying-in arm 241 is installed in a direction along a short direction of the stop range B and can be moved by a stroke length of a cylinder in the short direction in accordance with an operation of the cylinder based on the control of control unit 242. A parallel arrangement interval of the carrying-in arms 241 corresponds to an interval between the forklift holes in pallet P when the pallet P is placed on the pallet frame 11. Similarly to the carrying-out arm 221, for example, the carrying-in arm 241 which are smaller in number than the pallet containing parts may be installed, for example, only one carrying-in arm 241 may be installed or one carrying-in arm 241 may be installed in each stage of the pallet frame 11, and the carrying-in arm 241 may be configured to move to be able to correspond to any one pallet containing part.

A control circuit such as a PLC or a processor such as a CPU is used as the control unit 242, and the control unit 242 controls the components of the carrying-in apparatus 204. The control unit 242 detects the transportation device 1 (or the container C) that has moved from the carrying-out apparatus 201 and stopped in the stop range B, and acquires device identification information (or container identification information) of the stopped the transportation device 1 (or the container C). One first reader 243 is installed in each carrying-in arm 241 and reads containing part identification information from each tag 114 attached to each pallet containing part of the pallet frame 11 of the loading platform of the stopped the transportation device 1 (the container C). The first reader 243 is a camera that images the pallet frame 11 from the loading platform side of the stopped the transportation device 1 (the container C) and may read attached numbers or characters at once. The weight sensor 244 is a sensor that measures the weight of the pallet P and may be incorporated in the carrying-in arm 241. The second reader 245 is attached as a set of the weight sensor 244 and reads the pallet identification information of the pallet P to be carried in from the tag PT. The second reader 245 may be a reader such as an RFID or may be a device that reads the pallet identification information by image processing when the tag PT is a two-dimensional bar code. The communication unit 246 is a communication device that realizes a communication connection with the base server 21 in the base center 2 in a wireless or wired manner. Accordingly, the control unit 242 checks a correspondence between the pallet P and the pallet containing part to which the pallet P is to be carried in and instructs an operation after it is confirmed that the weight of the pallet P is correct. The writer 247 is a device that writes information in the tag PT of the pallet P or the tag 114 corresponding to the pallet containing part when it is a radio tag. The writer 247 writes the containing part identification information identifying the pallet containing part of the carrying-in destination in the tag PT of the pallet P or the tag 114 together with the vehicle identification information (container identification information). As the writer 247 writes the information in the carrying-in apparatus 204 that performs the import operation, it is possible to prevent the occurrence of a conflict information in the central server 3 to be described later and the fact that it is possible to carry in actually since the weight or the like is confirmed.

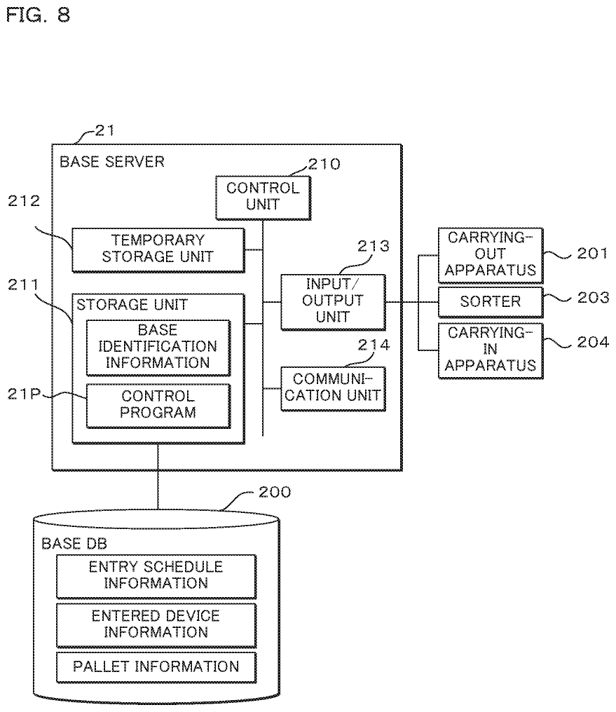

FIG. 8 is a block diagram illustrating a configuration of the base server 21 and the material handling system 20 in the base center 2. The base server 21 controls the operation of the material handling system 20 illustrated in FIGS. 6 and 7 by performing transmission and reception of information with the central server 3. The base server 21 includes a control unit 210, a storage unit 211, a temporary storage unit 212, an input/output unit 213, and a communication unit 214 using a server computer.

A CPU is used as the control unit 210, and the control unit 210 controls each component and the carrying-out apparatus 201, the sorter 203, and the carrying-in apparatus 204 of the material handling system 20 on the basis of a control program 21P stored in the storage unit 211. The temporary storage unit 212 is a memory such as a dynamic random-access memory (DRAM) and provisionally stores information generated by a process of the control unit 210. A hard disk is used as the storage unit 211. The storage unit 211 stores the control program 21P referred to by the control unit 210 in addition to base identification information for distinguishing the base center 2 corresponding to the base server 21 from the other the base centers 2. The storage unit 211 is connected to an external storage apparatus (or in the storage unit 211), and a base DB 200 is stored in the external storage apparatus. The base DB 200 stores vehicle identification information or container identification information of the transportation device 1 which is heading to the corresponding the base center 2 and is not entered in the carrying-out apparatus 201 yet, each piece of position information, and entry schedule information including an entry order (queue). Further, the base DB 200 includes entered device information indicating the vehicle identification information or the container identification information of the transportation device 1 before it is carried in by the carrying-in apparatus 204 after it is carried out in the carrying-out apparatus 201 in the base center 2. Further, the base DB 200 stores a list of pallet identification information of the pallet P existing in the material handling system 20 of the base center 2 and pallet information indicating each state (carry-out, waiting in the sorter 203, carry-in, and exited).

The input/output unit 213 is a control board connected to the carrying-out apparatus 201, the sorter 203, and the carrying-in apparatus 204, and outputs a control signal to the components of the material handling system 20 using the PLC. The communication unit 214 is a network card or a radio communication device that realizes a communication connection with the central server 3 via the network N. The control unit 210 acquires the vehicle identification information or the container identification information and each piece of position information of the transportation device 1 heading to the corresponding base center 2 from the communication unit 214 and acquires information of an article such as the weight associated with the identification information of the pallet P.

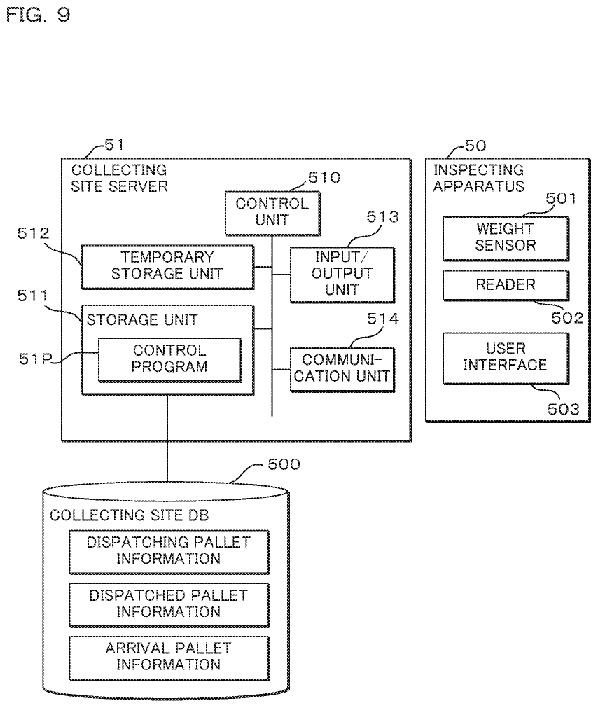

The collecting site server 51 and the inspecting apparatus 50 are installed in the collecting center 5. FIG. 9 is a block diagram illustrating configurations of the collecting site server 51 and the inspecting apparatus 50 in the collecting center 5. The inspecting apparatus 50 includes a weight sensor 501 and a reader 502 that reads the pallet identification information from the tag PT of the pallet P. Each of the weight sensor 501 and the reader 502 may be a single unit, may be handled by an operator, or may be combined with each other to simultaneously perform measuring of the weight of one pallet P on which the crop F is placed and reading from the tag PT through a control circuit. The pallet identification information and the weight of the pallet P read by the inspecting apparatus 50 are acquired by the collecting site server 51 in association with each other. The acquisition can be performed manually by the operator, and when the inspecting apparatus 50 controls the weight sensor 501 and the reader 502 by the control circuit, the inspecting apparatus 50 automatically transmits them to the collecting site server 51 by wireless or wired communication. The inspecting apparatus 50 includes a user interface 503 including a keyboard and a display and may accept an input of information other than the weight and the pallet identification information and associate it with the pallet identification information. For example, an input of an item of the placed crop F, a quantity thereof, information indicating whether or not it is refrigerated, a collection date, each delivery number, a destination base center 2, consignee information, sender information, or the like may be received as the information.

A server computer is used as the collecting site server 51, and the collecting site server 51 includes a control unit 510, a storage unit 511, a temporary storage unit 512, an input/output unit 513, and a communication unit 514.

A CPU is used as the control unit 510, and the control unit 510 controls each component on the basis of a control program 51P stored in the storage unit 511. The temporary storage unit 512 is a memory using a RAM such as a DRAM and provisionally stores information generated by a process of the control unit 510. A hard disk is used as the storage unit 511, and the storage unit 511 stores information referred to by the control unit 510 in addition to the control program 51P described above. The storage unit 511 stores a collecting site DB 500 including the pallet information including the pallet identification information of the pallet P in which the crop F is placed in the collecting center 5 in the storage unit 511 or in the external storage apparatus. As illustrated in FIG. 9, in the case of the pallet information of the collecting site DB 500, pallet information of the pallet P dispatched from the collecting center 5 serving as the departure point and pallet information of the pallet P arrived at the collecting center 5 serving as the destination may be stored separately as dispatching pallet information and arrival pallet information, respectively. The pallet information of the pallet P that has already been dispatched but has not arrived at the destination may be stored as the dispatched pallet information.

The pallet information includes a weight (a weight at the time of shipping) corresponding to the pallet identification information read by the inspecting apparatus 50. As described above, an item of the crop F placed on the pallet P input via the user interface, a quantity, information indicating whether or not it is refrigerated, a collection date, each delivery number, a destination base center 2, a desired arrival time, consignee information, sender information, or the like is preferably stored in the pallet information in association with each other. If the information is stored in the pallet P while distribution is being performed in the logistics system 100, traceability is improved.

The input/output unit 513 is an interface for connection with the inspecting apparatus 50, and the control unit 510 can automatically acquire information from the weight sensor 501, the reader 502, and the user interface 503 when the inspecting apparatus 50 is connected to the input/output unit 513.

The communication unit 514 is a network card or a radio communication device that realizes a communication connection with the central server 3 via the network N. The control unit 510 transmits the pallet information of the pallet P whose weight is measured by the inspecting apparatus 50 from the communication unit 514 to the central server 3 and acquires the information of the pallet P in the logistics system 100 from the central server 3.

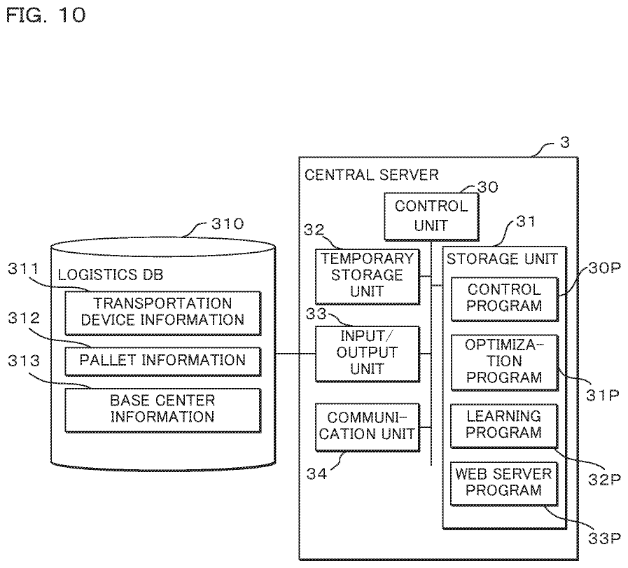

FIG. 10 is a block diagram illustrating a configuration of the central server 3. The central server 3 collects all pieces of information in the transportation device 1, the container C, the pallet P, the base center 2, and collecting center 5 illustrated in FIG. 3 to FIG. 9, and performs central control for performing a process of obtaining an optimal solution to realize efficient transportation. The central server 3 is expected to be operated by an organization that conducts activities across an agricultural cooperative in each region that operates the collecting center 5 such as, for example, the National Federation of Agricultural Cooperative and associations or Japans Central Union of Agricultural Cooperative.

The central server 3 includes a control unit 30, a storage unit 31, a temporary storage unit 32, an input/output unit 33, and a communication unit 34. The central server 3 may be not only a configuration using a single server computer (hardware) but also a configuration in which a process is distributed to a plurality of server computers.

A CPU is used as the control unit 30, and the control unit 30 controls each component on the basis of a control program 30P stored in the storage unit 31 and an optimization program 31P. The temporary storage unit 32 is a scale such as a DRAM, and provisionally stores information generated by a process of the control unit 30. A hard disk is used as the storage unit 31. In addition to the control program 30P and the optimization program 31P described above, various programs such as a database operation module and information referred to by the control unit 30 are stored in the storage unit 31. A learning program 32P and a web server program 33P are separately stored in the storage unit 31 as illustrated in FIG. 10.

The input/output unit 33 is a connection interface with an external storage apparatus. The control unit 30 can perform reading/writing from/to the logistics DB 310 stored in the external storage apparatus via the input/output unit 33 by the database operation module.

The communication unit 34 is a network card that realizes information communication via the network N. The control unit 30 can perform communication connection with the base server 21 of each base center 2 and the collecting site server 51 of the collecting center 5 via the communication unit 34. The control unit 30 can acquire the position information of each transportation truck 1 acquired via the carrier network N2 through the communication unit 34.

The logistics DB 310 in the external storage apparatus can be accessed from the central server 3 and the central server 3M which is a mirror. The logistics DB 310 includes transportation device information 311, pallet information 312, and base center information 313. For these pieces of information, only the latest information at that time may be updated, and history information may be stored separately. The transportation device information 311 stores position information (a current location) and operation information including a destination for each piece of identification information of the transportation device 1 (the vehicle identification information, the aircraft identification information, the ship identification information, and the vehicle identification information) and may further store a transit point to the destination and driver identification information. The pallet information 312 is information in which the pallet information transmitted from the collecting site server 51 of the collecting center 5 is collected. The pallet information 312 includes at least the pallet identification information and the weight of the pallet P. The other information is similar to the information described above regarding the collecting site server 51. Further, the pallet information 312 is associated with information specifying the pallet containing part contained in association with the pallet identification information of all the pallets P, that is, the containing part identification information. A combination of the identification information is a combination of the vehicle identification information and the containing part identification information or a combination of the aircraft identification information, the ship identification information, or the vehicle identification information, the contained container identification information, and the containing part identification information in the container C. Accordingly, it is possible to track the pallet containing part in which the pallet P is contained in the transportation device 1 moving a certain position (for example, a latitude and a longitude) at that time. The base center information 313 is associated with the pallet identification information of the pallet P which is currently in the base center 2 at that time, the vehicle identification of the transportation truck 1 which is being entered in the base center 2, and the container identification information of the container C in addition to the base identification information and the location of each base center 2.

The transport control by the transportation device 1 including the pallet frame 11, the pallet P, the base center 2, and the collecting center 5, the central server 3 as illustrated in FIGS. 3 to 10 will be described below. First, the control in the collecting center 5 of the transportation truck 1 and the pallet P and the base center 2 that realize one round trip per day as described with reference to FIG. 1 will be described below.

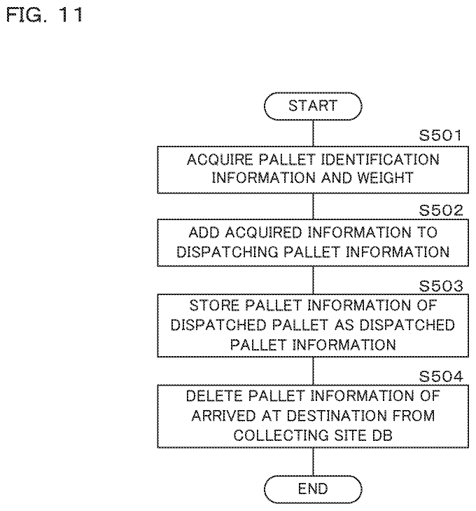

FIG. 11 is a flowchart illustrating an example of a processing procedure in the collecting site server 51. In the process procedure to be described below, description of a process in the collecting center 5 which is the destination of the pallet P is omitted.

The control unit 510 of the collecting site server 51 acquires the pallet identification information and the weight read by the inspecting apparatus 50 of the collecting center 5 and other information (step S501), and adds the acquired pallet identification information, the weight, and the other information to the dispatching pallet information (step S502). If the pallet P is transported to the base center 2, the control unit 510 stores the pallet information in the dispatching pallet information in the collecting site DB as the dispatched pallet information (step S503). Upon receiving a notification indicating that the pallet information included in the dispatched pallet information has arrived at the destination from the central server 3, the control unit 510 deletes the pallet information from the collecting site DB (step S504) and ends the process.

The control unit 510 of the collecting site server 51 updates the collecting site DB 500 by repeating the procedure illustrated in the flowchart of FIG. 11 or simultaneously performing a part of the procedure illustrated in the flowchart of FIG. 11 in parallel.

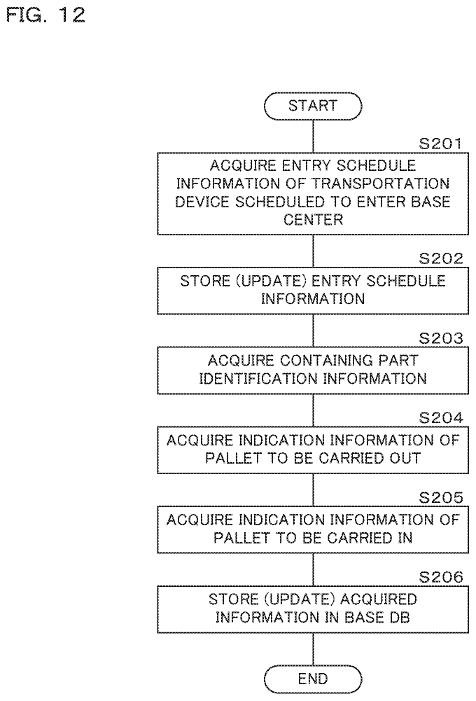

FIG. 12 is a flowchart illustrating an example of a first processing procedure in the base server 21. The control unit 210 of the base server 21 acquires entry schedule information indicating the device identification information of the transportation device 1 scheduled to enter the base center 2 corresponding to its own apparatus from the central server 3 (step S201). The control unit 210 stores (or updates) the acquired entry schedule information in the base DB 200 (step S202). The entry schedule information is information obtained by listing the device identification information of the transportation device 1 or the container identification information of the container C included in the transportation device 1 in an order of entry scheduled times.

The control unit 210 acquires the containing part identification information for each transportation device 1 or each container C scheduled to enter the basis of the loading schedule information (step S203).

The control unit 210 acquires instruction of the pallet P to be carried out in the base center 2 corresponding to its own apparatus from the loading platform of the transportation device 1 from the central server 3 for each transportation device 1 indicated by the device identification information included in the loading schedule information acquired and stored in steps S201 and S202 (step S204). The instruction acquired in step S204 includes a correspondence between the pallet identification information and the containing part identification information of the pallet containing part containing the pallet P to be carried out. For the instruction, in a case in which the target transportation device 1 is a transport aircraft, a ship, a train, or the like and uses the container C, the control unit 210 acquires the pallet identification information and the corresponding containing part identification information for each piece of container identification information of container C. Each piece of containing part identification information of the pallet containing part may include information identifying the position of the containing part in the loading platform or the container C.

Further, the control unit 210 acquires the instruction of the pallet P to be carried in from the central server 3 for each transportation device 1 or each container C scheduled to enter (step S205). The instruction acquired in step S205 includes a correspondence of the pallet identification information and the containing part identification information identifying the pallet containing part of the carrying-in destination.

The control unit 210 stores and updates the information acquired in the processes from step S201 to S205 in association with each transportation device 1 or each container C of the entry schedule information of the base DB 200 (step S206).

The control unit 210 of the base server 21 repeats the procedure illustrated in the flowchart in FIG. 12 each time a predetermined time elapses or executes the process of step S202 to S206 each time the entry schedule information from the central server 3 is received in step S201. Accordingly, the latest correspondence related to the carrying-out of the entry schedule information indicating the transportation device 1 scheduled to enter the base center 2, the pallet identification information of the pallet P to be carried out from each transportation device 1, and the containing part identification information of the pallet containing part containing the pallet P to be carried out is stored and updated in the base DB 200. Similarly, the latest correspondence related to the carrying-in of the device identification information of the transportation device 1 scheduled to enter the base center 2, the pallet identification information of the pallet P to be carried out to the transportation device 1, and the containing part identification information of the pallet containing part in which the pallet P to be carried in is to be contained is stored in the entry schedule information in the base server 21. These pieces of information are decided by a process to be described later in the central server 3.

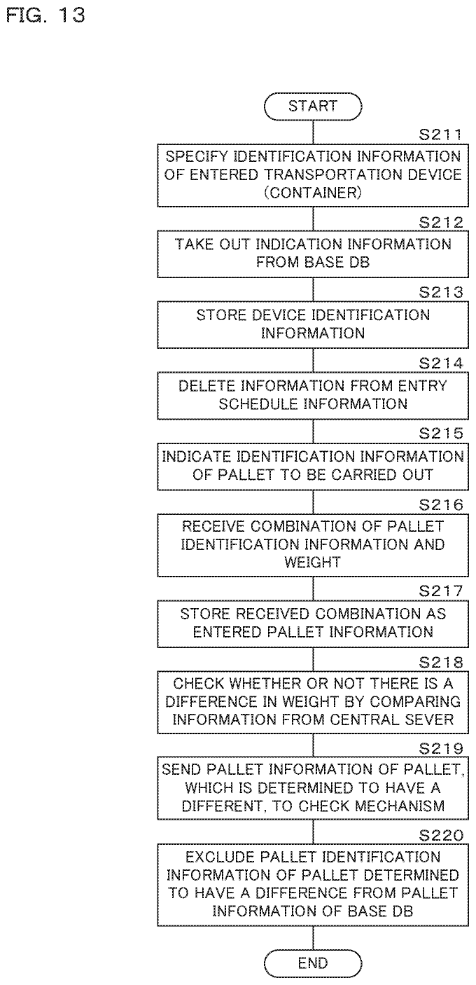

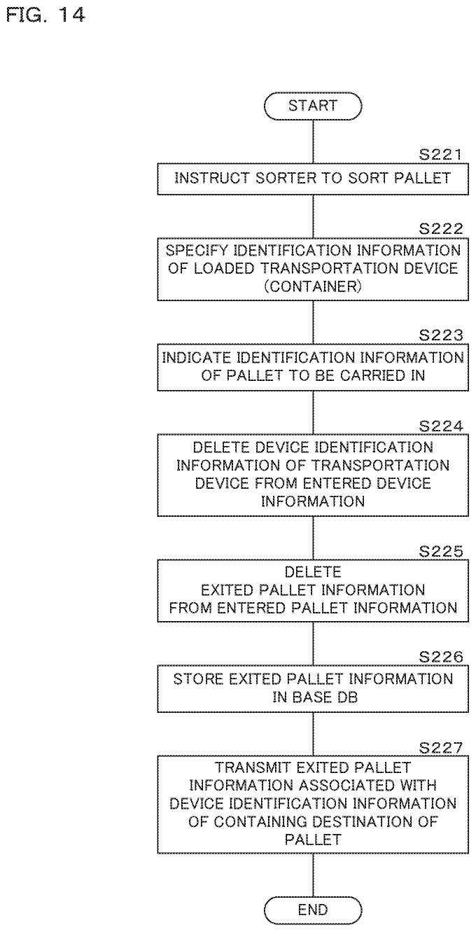

FIG. 13 is a flowchart illustrating an example of a second processing procedure (carrying-out) in the base server 21. The control unit 210 of the base server 21 repeatedly executes the process in the flowchart of FIG. 12 and simultaneously executes the carrying-in/out process illustrated in the flowcharts of FIG. 13 and FIG. 14 to be described later.

The control unit 210 specifies the device identification information or the container identification information of the transportation device 1 detected by the carrying-out apparatus 201 (step S211). The control unit 210 takes out the carrying-in/out instruction related to the identified device identification information or container identification information from the base DB 200 (step S212). The control unit 210 stores the device identification information or container identification information of the detected transportation device 1 in association with state information indicating that the carrying-out process is in progress in the entered device information in the base DB 200 (step S213), and deletes the information related to the detected transportation device 1 from the entry schedule information (step S214).

The control unit 210 outputs an indication signal indicating the information related to the carrying-out from the detected transportation device 1, that is, the pallet identification information of the pallet P to be carried out and the containing part identification information containing the pallet P to be carried out from the input/output unit 213 to the carrying-out apparatus 201 (step S215). The carrying-out apparatus 201 causes the loading platform of the transportation device 1 or the container C to operate the carrying-out arm 221 corresponding to the pallet containing part containing the pallet P to be carried out on the basis of the instruction from the base server 21 and carries out the pallet P. The carrying-out apparatus 201 measures the pallet identification information and the weight of the carried-out pallet P.

The control unit 210 receives the combination of the pallet identification information and the weight of the carried-out pallet P whose weight is measured from the carrying-out apparatus 201 (step S216), and adds it to the pallet information of the base DB 200 (step S217). In step S216, the control unit 210 stores the received pallet identification information in the base DB 200 as the entered pallet information indicating the pallet P entered the base center 2 corresponding to its own apparatus, and transmits it to the central server 3. Then, in step S216, the control unit 210 stores the pallet identification information of the pallet P transported from the collecting center 5 in the area corresponding to the base center 2 by other trucks as well as the pallet P carried out of the entered transportation device 1 or the container C by the carrying-out apparatus 201 as the entered pallet information, and transmits it to the central server 3.

The control unit 210 compares the combination of the pallet identification information and the weight acquired from the central server 3 with the combination received from the carrying-out apparatus 201, and checks whether or not there is a difference in weight (step S218). The control unit 210 sends pallet identification information of the pallet P which is determined to have a difference in weight in step S218 to a check mechanism for checking whether there is any fraud such as replacement or addition of an article (step S219). The control unit 210 excludes the pallet identification information of the pallet P determined to have a difference from the pallet information of the base DB 200 by setting it to pending in the base DB 200 (step S220), and ends the process related to the carrying-out.

The transportation device 1 or the container C then enters the carrying-in apparatus 204. FIG. 14 is a flowchart illustrating an example of a third processing procedure (carrying-in) in base server 21.

The control unit 210 stores the pallet identification information of the pallet P to be carried in from the central server 3 to the transportation device 1 heading for the base center 2 corresponding to its own apparatus and the containing part identification information of the containing part which is to contain the pallet P through the first processing procedure illustrated in FIG. 12. Prior to entry the transportation device 1 in the carrying-in apparatus 204 or desirably to the carrying-out apparatus 201, the control unit 210 instructs the sorter 203 to sort the pallet P on the basis of the entry schedule order of the entry schedule information (step S221).

The control unit 210 specifies the device identification information or the container identification information of the transportation device 1 detected by the carrying-in apparatus 204 (step S222). The control unit 210 outputs an indication signal indicating the information related to the carrying-in to the detected transportation device 1, that is, the pallet identification information of the pallet P to be carried in and the containing part identification information of the pallet containing part in which the pallet P to be carried in is to be contained from the input/output unit 213 to the carrying-in apparatus 204 (step S223). The carrying-in apparatus 204 specifies the pallet identification information of the pallet P being carried by the lines 202 and 205 by the sorting of the sorter 203 since it is to be carried in the loading platform of the transportation device 1 or the container C on the basis of the instruction from the base server 21. The carrying-in apparatus 204 carries the pallet P in each pallet containing part while checking whether or not the pallet containing part of the containing destination is empty on the basis of the instruction.

If a notification indicating that the carrying-in in the carrying-in apparatus 204 is completed, the control unit 210 deletes the device identification information of the transportation device 1 of the carrying-in target (or the container identification information of the container C) from the entered device information since it is exited (step S224). The control unit 210 sets the pallet identification information of the carried-in pallet P as the exited pallet information indicating the exited pallet P and deletes it from the entered pallet information (step S225) and stores it in the base DB 200 (step S226). The control unit 210 stores information in which the exited pallet information is associated with the device identification information of the transportation device 1 of the containing destination (or the container identification information of the container C) in the base DB 200, transmits it to the central server 3 together with the exit time (step S227), and ends the process. In step S225, the control unit 210 may transmit information of a capacity of a buffer shelf and a free space in the sorter 203 in the base center 2 and information indicating the position of the pallet P stored in the buffer shelf (identification information identifying each shelf of the buffer shelf) to the central server 3.

The control unit 210 of the base server 21 instructs each component of the material handling system 20 to perform an operation on the basis of the information from the central server 3 while repeating the procedures illustrated in the flowchart of FIG. 12 to FIG. 14 or simultaneously performing some of the procedures illustrated in the flowchart of FIG. 12 to FIG. 14 in parallel and updating the base DB 200.

In the process procedure indicated by the flowchart in FIG. 12, in steps S201 to S204, the base server 21 acquires the information stored as the entry schedule information in the base DB 200 from the central server 3. Specifically, in addition to the device identification information of the transportation device 1 scheduled to enter the base center 2 and the containing part identification information of the pallet containing part included in the transportation device 1, the pallet identification information of the pallet P to be carried out of the transportation device 1 and the pallet identification information of the pallet P to be carried in the transportation device 1 are acquired. These pieces of information are derived from the central server 3.

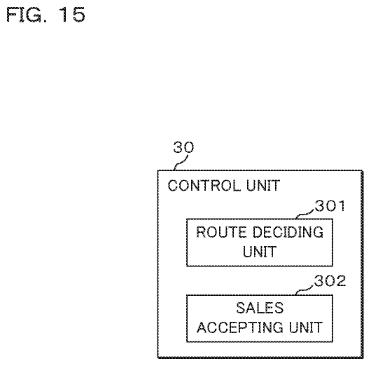

Next, a process in the central server 3 will be described. FIG. 15 is a functional block diagram illustrating an overview of the process in the central server 3. The control unit 30 of the central server 3 functions as a route deciding unit 301 and a sales accepting unit 302.

The route deciding unit 301 decides a distribution route of the pallet P to be transported in which the articles are actually accumulated (the pallet P corresponding to the pallet identification information stored in the collecting site DB 500 as the pallet information) and a transport route of the transportation device 1, that is, a time and a place of the base center 2 through which the transportation device 1 is to pass. The route deciding unit 301 obtains a result by initially associating the pallet identification information of each pallet P with the containing part identification information in the loading platform of the transportation device 1 scheduled to be operated or the container C to enter provisionally and optimizing the transportation route of the transportation device 1 and the association (a containing address of the pallet P) between the pallet identification information and the containing part identification information under a predetermined condition. Here, the sharing efficiency is improved by associating the pallet P with the pallet containing part instead of the transportation device 1 and optimizing it. First, the predetermined condition includes a destination of each pallet P and a desired arrival date and time. Further, the predetermined condition is, for example, a condition of the transportation route of the transportation device 1 (for example, a condition that a single continuous operation in which the transportation device 1 can return to the departure point after one round trip within a working time of one day of the driver is four hours at the longest from the departure point).

First, the process by the route deciding unit 301 is performed before the transportation of each pallet P from each collecting center 5 starts, for example, twice or more within one day before the transportation device 1 departs. It may be performed once a day on the basis of a shipping schedule of the day. The route decision before the transportation device 1 departs is performed to first decide the pallet containing part of the transportation device 1 in which each pallet P is to be contained. The route deciding unit 301 reviews and re-decides the route even for the transportation device 1 and the pallet P in transit by sequentially repeating it, for example, every 10 minutes, every 30 minutes, or the like even after the transportation is started. The control unit 30 gives an entry schedule notification of the corresponding transportation device 1 to the base server 21 of the base center 2 when a certain transportation device 1 arrives at a position within a predetermined distance from a certain base center 2 or when it becomes a predetermined time before an arrival time (estimation). The route may be reviewed through the route deciding unit 301 before the entry schedule notification is given. The route re-decision may be performed at a timing at which an event such as a delay occurs on the basis of traffic information or operation information.

The sales accepting unit 302 accepts the sales of the possessory right (ticket) of the loading platform or the container C in units of the pallet containing parts in the loading platform of the transportation device 1 or the container C to be loaded. The sales accepting unit 302 receives information such as a scheduled shipping date of a package, an item, the number of shipments, a consignee, a consignee address, and a desired arrival date and time via a web server through the information processing apparatus 6 and allocates the identification information of the pallet P in which the package is to be contained to the containing part identification information of an empty pallet containing part. An amount of money is decided in accordance with conditions of a distance and a desired arrival date and time, and payment may be made in advance or afterwards by other payment services. It may be discounted in the case of early reservation discounts. In a case in which there is a distribution route and a transport route satisfying a departure date and time among the distribution routes of the pallet P and the transportation routes of the transportation device 1 decided by the route deciding unit 301, the sales accepting unit 302 may allocate the empty pallet P and the pallet containing part to a new package. However, since the sales is performed before the pallet P is collected in the collecting center 5, the sales accepting unit 302 performs the demand forecasting and the operation forecasting of the transportation device 1 on the basis of an actual transportation record, the information of the transportation device 1, and environmental conditions (a region, a season, an event, or singularity) in advance, and accepts the sales of the ticket from the forecasting result. The demand forecasting will be described later.

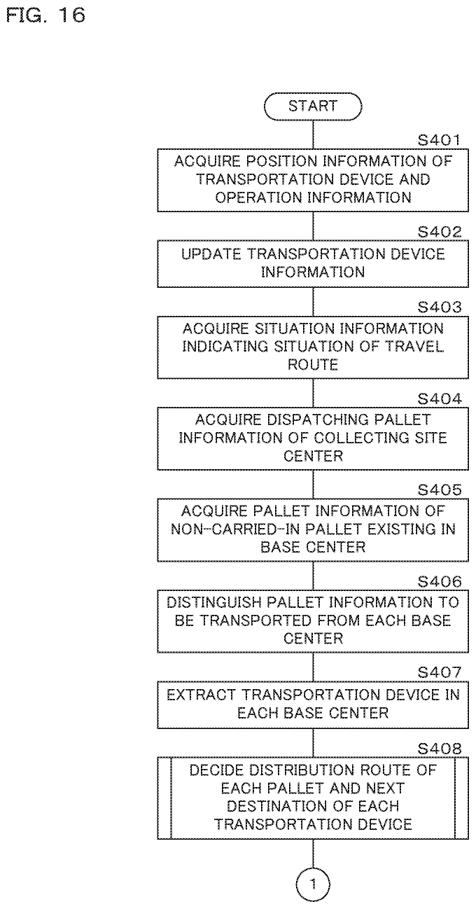

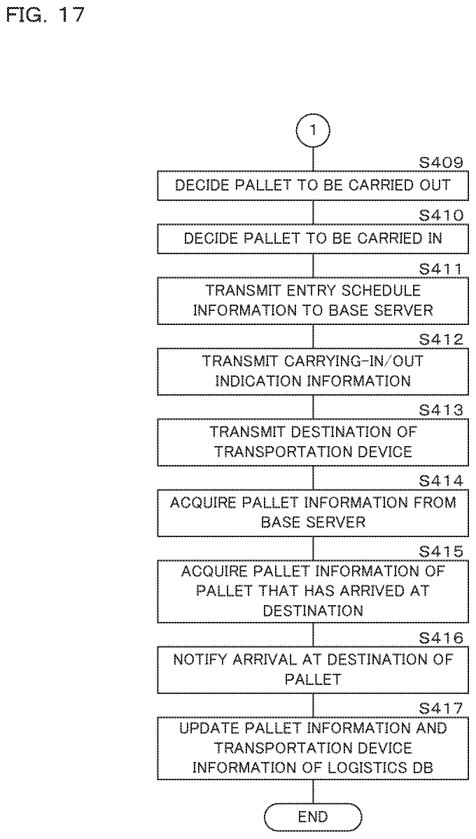

The process of the route deciding unit 301 will be described with reference to a flowchart. FIGS. 16 and 17 are flowcharts illustrating an example of a processing procedure by the control unit 30 of the central server 3. The control unit 30 of the central server 3 performs the process procedures illustrated in the flowchart of FIGS. 16 and 17 as a plan before the transportation starts as described above, and also sequentially executes them even after the transportation starts.

The control unit 30 acquires the position information of all the transportation devices 1 and operation information including a destination (direction), a traveling distance, a continuous operation time, or the like (step S401). The control unit 30 updates the transportation device information 311 with the acquired position information and the operation information (step S402). Further, the control unit 30 acquires situation information indicating a situation of a transportation route such as a road network, a route, an air route, or a railroad from an external server via the network N (step S403). The situation information includes traffic information, delay information, travel time information, traffic jam information, construction section information, or the like.

The control unit 30 acquires the dispatching pallet information (a destination, a desired arrival time, or the like) of the not-dispatched pallet P in the collecting center 5 in each place from the collecting site server 51 in association with the identification information (location) of the collecting center 5 (step S404). The control unit 30 also acquires the pallet information (the destination, the desired arrival time, or the like) associated with the pallet identification information of the non-carried-in pallet P existing in the material handling system 20 of the base center 2 from the base server 21 in each place in association with the identification information of the base center 2 (step S405).

For each base center 2, the control unit 30 distinguishes the pallet identification information of the pallet P to be transported from the base center 2 (including the non-dispatched pallet P in the nearest collecting center 5) on the basis of the base center 2 of the destination and a desired arrival date and time at which it is to arrive at the base center 2 (step S406).

The control unit 30 extracts the transportation device 1 (the transportation device 1 before entry) that remains in the base center 2 or the transportation device 1 having the base center 2 as the destination (the destination or the transit point) on the basis of the current position in the transportation device information 311 updated in step S402 for each base center 2 (step S407). In step S407, the control unit 30 may generate a queue of the transportation device 1 in the ascending order of the scheduled entry times.

The control unit 30 associates the pallet identification information of the pallet P distinguished for each destination and the desired arrival date and time in step S406 with the containing part identification information of the pallet containing part of the transportation device 1 extracted in step S407 and decides the distribution route of each pallet P and the next destination of each transportation device 1 (the base center 2 to stop by or the base center 2 serving as the destination) (step S408). In step S408, the control unit 30 decides the destination of the transportation device 1 under a predetermined condition. As described above, the predetermined condition is a condition that a single continuous operation in which the transportation device 1 can return to the departure point after one round trip within a working time of one day of the driver is four hours at the longest from the departure point. The process of deciding the distribution route and the destination of the transportation device 1 in step S418 will be described later.

The control unit 30 decides the pallet P to be carried out of each transportation device 1 extracted in step S407 for each transportation device 1 on the basis of the distribution route of each pallet P decided in step S408 (step S409). If there is no pallet P to be carried out, it can be decided that it does not exist. The control unit 30 decides the pallet P to be carried in each transportation device 1 extracted in step S407 for each transportation device 1 on the basis of the distribution route of each pallet P decided in step S408 (step S410). If it is a transportation device 1 that has finished the transportation and there is no pallet P to be carried in, it may be decided that it does not exist. The control unit 30 transmits the information of the transportation device 1 extracted in step S407 (the queue of the entry schedule time order) to the base server 21 as the entry schedule information (step S411). The control unit 30 transmits the carrying-in/out instruction corresponding to the received information of the transportation device 1 to the base server 21 (step S412). The carrying-in/out instruction indicates a correspondence between the pallet identification information of the pallet P of each transportation device 1 decided in steps S409 and S410, the pallet containing part in which the pallet P is contained, and the containing part identification information of the pallet containing part serving as the containing destination.

The control unit 30 transmits the destination (transportation route) of the transportation device 1 decided in step S408 to the communication device of the transportation device 1 or the mobile terminal apparatus carried by the driver (step S413). Upon receiving the information indicating the destination, the communication device or the mobile terminal apparatus may give a notification indicating the destination to the driver using a navigation program. The transportation device 1 may include an automatic driving control function, and in this case, the transportation device 1 receives a destination instruction via the communication device and operates.

Then, the control unit 30 acquires the pallet identification information (the exited pallet information) of the pallet P that has been carried in, that is, exited in the transportation device 1 from the base server 21 in each place (step S414). The pallet identification information is associated with the containing part identification information containing the pallet P.

Among the pallet P carried out in the base center 2, the pallet P having the base center 2 in which the pallet P is carried out as the destination is collected in the corresponding collecting center 5 or the collecting center 5 installed in parallel with (doubling as) the base center 2 on the basis of the consignee information. The collecting center 5 inspects them through the inspecting apparatus 50, detects that the pallet P has arrived at the destination, and gives a notification indicating the pallet identification information of the pallet P to the collecting site server 51. The collecting site server 51 stores the pallet identification information notified as the arrival pallet information in the collecting site DB 500.

The control unit 30 of the central server 3 acquires the pallet information of the pallet P that has arrived at the destination from the collecting site server 51 in each place (step S415). The control unit 30 notifies the collecting site server 51 of the sender of the arrival (step S416). Then, the control unit 30 updates the transportation device information 311, the pallet information 312, and the base center information 313 of the logistics DB 310 on the basis of the information acquired in steps S414 and S415 (step S417), and ends the process. In step S417, the information is updated with the latest information of the pallet contained in the transportation device 1 which is moving after departing from the base center 2, and the information of the pallet arriving at the destination is deleted. Accordingly, the location of the pallet P being transported is detected by the central server 3.

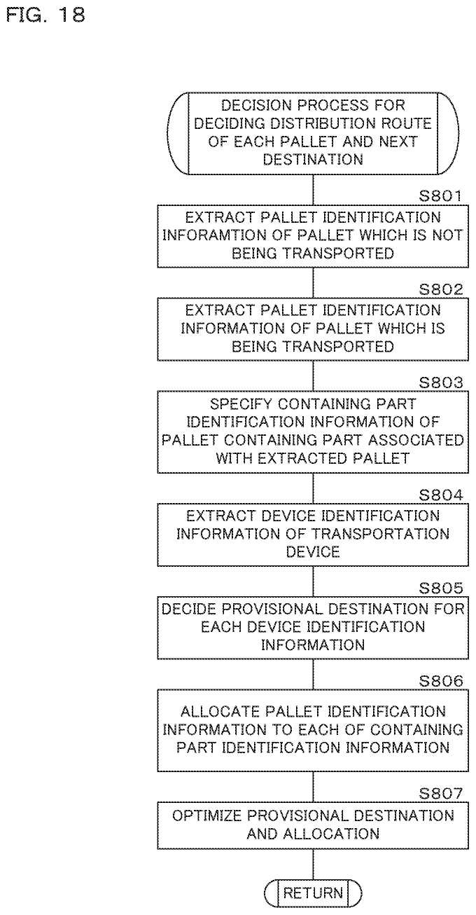

FIG. 18 is a flowchart illustrating an example of a procedure for deciding the distribution route of the pallet P and the transportation route of the transportation device 1. The processing procedure illustrated in the flowchart in FIG. 18 corresponds to the details of step S408 in the process procedure illustrated in the flowchart in FIGS. 16 and 17. The control unit 30 of the central server 3 executes the following process as the route deciding unit 301. The control unit 30 may perform the following process for each base center 2.

The control unit 30 extracts the pallet identification information of the pallet P which is not being transported as the distribution route determination target (step S801). In step S801, the control unit 30 first extracts, for example, the pallet identification information of the non-dispatched pallet P extracted in the collecting center 5 corresponding to the target base center 2 and the pallet identification information of the pallet P whose carrying-in destination is not decided although it remains in the target base center 2.

The control unit 30 extracts the pallet identification information of the pallet P being transported as the distribution route decision target (step S802). In step S802, the control unit 30 also extracts, for example, the pallet identification information of the pallet P being contained in the loading platform of the transportation device 1 leading for the target base center 2 or the container C to be loaded.

The control unit 30 specifies the containing part identification information of the pallet containing part already associated with the extracted pallet identification information together with the estimation that it can be carried out in the target base center 2 (step S803). In step S803, the control unit 30 specifies empty information in the pallet identification information whose containing destination is not yet associated (the pallet identification information of the pallet P which is not actually contained).

The control unit 30 extracts the device identification information of a plurality of transportation devices 1 to enter or exit from the target base center 2 after a predetermined time in the ascending order of the scheduled exit times (step S804). The control unit 30 provisionally decides the destination for the device identification information of the transportation device 1 extracted in step S804 (step S805). In step S805, the control unit 30 first makes a decision on the basis of the operation information in the transportation device information 311 on the basis of the transportation route at that time.

The control unit 30 allocates the pallet identification information extracted in step S801 and step S802 to each of the containing part identification information of the pallet containing part of the loading platform of the transportation device 1 identified by the device identification information extracted in step S804 or the containing part identification of the pallet containing part of the container C loaded in the transportation device 1 one by one (step S806). In step S806, the control unit 30 allocates the pallet identification information of the pallet P in which the stopover order of the base center 2 in the distribution route matches the destination provisionally decided in step S805, and an estimated time at which it can be carried in the base center 2 satisfies a condition. In the pallet identification information of the pallet P, when the dispatching is accepted, the containing part identification information of each pallet containing part scheduled to stop by to the destination may be associated in order by a combination with the transportation device identification information (and the container identification information), may be allocated on the basis of the schedule, or may be newly allocated in accordance with conditions that can change from time to time.

In step S806, the containing part identification information of the pallet containing part in each of a plurality of transportation devices 1, the pallet identification information of the pallet P to be contained, the destination of each pallet P, and the destination provisionally decided for the transportation device 1 are optimized under a condition that the arrival date and time of each pallet P is observed so that the number of transportable transportation devices 1 is kept, and the number of empty pallet containing parts is minimized (step S807). The optimization may be performed by repeatedly executing the process of step S804 to step S806. It is desirable to perform the optimization while changing the scheduled departure time (order) and the destination of the transportation device 1.

As a result of the process in step S807, for each transportation device 1 or each container C, a correspondence relation between the pallet identification information of the pallet P and the containing part identification information of the containing destination in which it is to be contained when it is carried in the carrying-in apparatus 204 is determined, and the pallet identification information of the pallet P to be carried out by the carrying-out apparatus 201 is decided.

As described above, the logistics system 100 in the present embodiment can carry in and out the article by the loading platform of the transportation device 1 or the container C using the pallet frame 11 in which the pallet containing part capable of containing the pallet P is distinguishable by the containing part identification information. In the logistics system 100, as described above, it is possible to specify each of all the pallet containing parts in the logistics system 100 by the combination of the identification information identifying the transportation device 1 and the containing part identification information of the pallet containing part. Specifically, the combination is a combination of the vehicle identification information and the containing part identification information or a combination of the aircraft identification information, the ship identification information, or the vehicle identification information, the container identification information, and the containing part identification information. In the logistics system 100, each transportation device 1 stops at the base center 2 and carries out some or all of the pallets P contained in the loading platform or the container C at the base center 2 of the transit point, and carries in and unloads the pallet P in the empty pallet containing part. In other words, the transportation device 1 does not keep containing all the transported articles from the departure point to the target point but can load or unload them at the base center 2 or contain new articles in the empty pallet containing part. Also, the base center 2 includes equipment (the carrying-out apparatus 201, the sorter 203, and the carrying-in apparatus 204) that performs the carrying-in/out in response to the instructions from the central server 3 and the base server 21. As described above, in the logistics system 100, the transportation device 1 side includes the pallet frame 11, and thus a mechanism capable of specifying which articles are contained or to be contained in which containing parts and further carrying in/out some of them in units of the pallets P and in units of the pallet containing part in the base center 2. With this mechanism, the central server 3 can re-decide which pallet P is to be carried out from which pallet containing part of the transportation device 1 (or the container C) and whether the pallet P is to be carried in the empty pallet containing part by detecting the empty pallet containing part before the transportation device 1 arrives at the base center 2 (an extension of a time necessary for the processes in the sorter 203 and the carrying-in/out apparatuses 201 and 204) in accordance with the transportation situation of the pallet P and the traffic information in the entire logistics system 100 at a time point at which the base center 2 arrives at the transportation device 1 after each transportation device 1 has already started the transportation. It is possible to control the entire route that the transportation device 1 travels (even international) as if it were a line in the material handling system.

In the logistics system 100 in the present embodiment, with the process of the sales accepting unit 302 of the control unit 30 of the central server 3, it is possible to purchase the possessory right (the transport ticket) of the pallet containing part of the transportation device 1 using the information processing apparatus 6 on the sender side or the consignee side of the article that desires to use the logistics system 100.

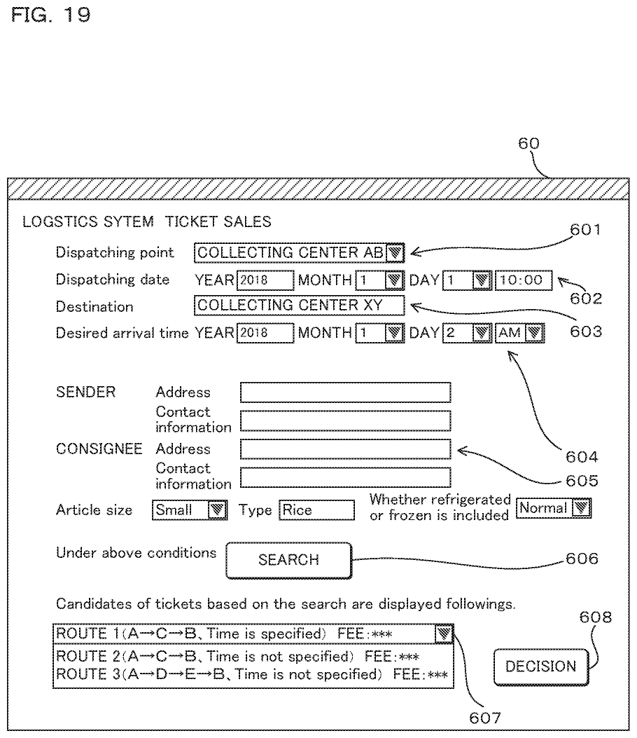

FIG. 19 is a diagram illustrating a content example of an interface installed by the central server 3. A web screen 60 illustrated in FIG. 19 is displayed on the information processing apparatus 6 in accordance with the process of the sales accepting unit 302 through the web server function on the basis of the web server program 33P stored in the storage unit 31 of the central server 3. The web screen 60 includes a selection field 601 for the collecting center 5 or the base center 2 in which the article to be transported is contained on the pallet P, a selection field 602 for a dispatching date, a consignee's address, a selection field 603 for the base center 2 corresponding to a residence, and a selection field 604 for a desired arrival time. Also, an input field 605 for conditions such as sender information, consignee information, an article size, a type, and whether refrigerated or frozen is also included. The web screen 60 includes a search button 606 that accepts a search for a distribution route based on information selected and input in the selection fields 601 to 604 and the input field 605. If the search button 606 is selected, a selection field 607 that enables candidate display and selection is displayed. The distribution route candidates displayed in the selection field 607 are displayed in association with the respective transport charges. Further, a decision button 608 used to select and decide one of the candidates is also displayed on the screen 60. It is desirable that the transport charge be linked with a payment system which is an external service or a payment system installed inside the system.

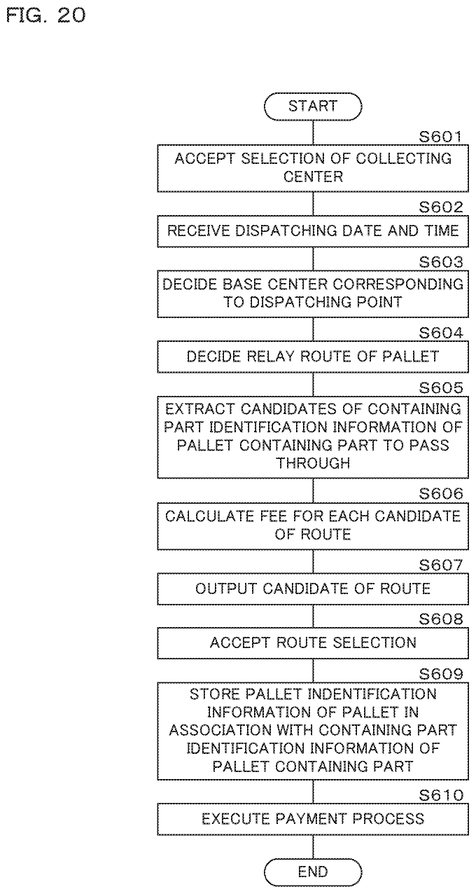

FIG. 20 is a flowchart illustrating an example of a ticket sales acceptance procedure for transportation in the logistics system 100. For example, when the search button 606 in the screen 60 illustrated as the content example in FIG. 19 is selected, the control unit 30 performs the following process.

The control unit 30 accepts the selection of the collecting center 5 or the base center 2 in which loading to the pallet P is performed by the function of the sales accepting unit 302 (step S601) and receives a dispatching date and time at which the pallet P can be dispatched (step S602).

The control unit 30 decides the base center 2 from which it is dispatched and the base center 2 serving as the destination from the selected collecting center 5 or the base center 2 (step S603). The control unit 30 decides a relay route of the base center 2 on the basis of the decided dispatching point and the destination (step S604). At this point, the control unit 30 extracts a series of containing part identification information associated with the containing part identification information of each of the pallet containing part capable of carrying it in at an estimated time and the pallet containing part to pass through to the destination as candidates by a plurality of patterns on the basis of a carrying-in time estimated on the basis of the decided relay route and the dispatching date and time selected in step S602 and the desired arrival time (step S605). The control unit 30 calculates the fee on the basis of the decided relay route and the extracted candidate containing part identification information (step S606), and outputs the selection field 607 of displaying a list of candidate relay routes together with the calculated fee (step S607).

The control unit 30 accepts the route selection in the selection field 607 (step S608), and stores the pallet identification information of the pallet P including the article loaded thereon to be dispatched in the logistics DB 310 in association with the containing part identification information of the pallet containing part of the first the transportation device 1 corresponding to the selected route (step S609). The control unit 30 executes the payment process (up front or in arrears) based on the selected route (step S610), and ends the process.

For the association decided in step S609, an identification number identifying the distribution route of the article to be dispatched may be issued, stored in association with an article transport request, and displayed on the information processing apparatus 6 after the reception process. With the identification number, it is desirable to reflect the actual distribution route of the dispatched article, that is, when the change is made so that it is possible to track the pallet containing part of the transportation device in which it is transported during the transportation.

The ticket purchase/sale is not limited to associating the pallet identification information of the pallet P with the containing part identification information of the empty pallet containing part in accordance with the situation of the logistics system 100 at that time. For the ticket purchase/sale, it is desirable to estimate the number of pallets P and the destination of each pallet P for each base center 2 serving as a dispatching point on the basis of the demand forecasting in advance in the central server 3. Then, the central server 3 shares the loading platform of the transportation device 1 or the container C in units of the pallet containing parts, and for each pallet P that has been subjected to the demand forecasted, the pallet containing part to pass to transfer the pallet P to the destination is decided by association with the pallet containing part and optimization of the transportation route of the transportation device 1.

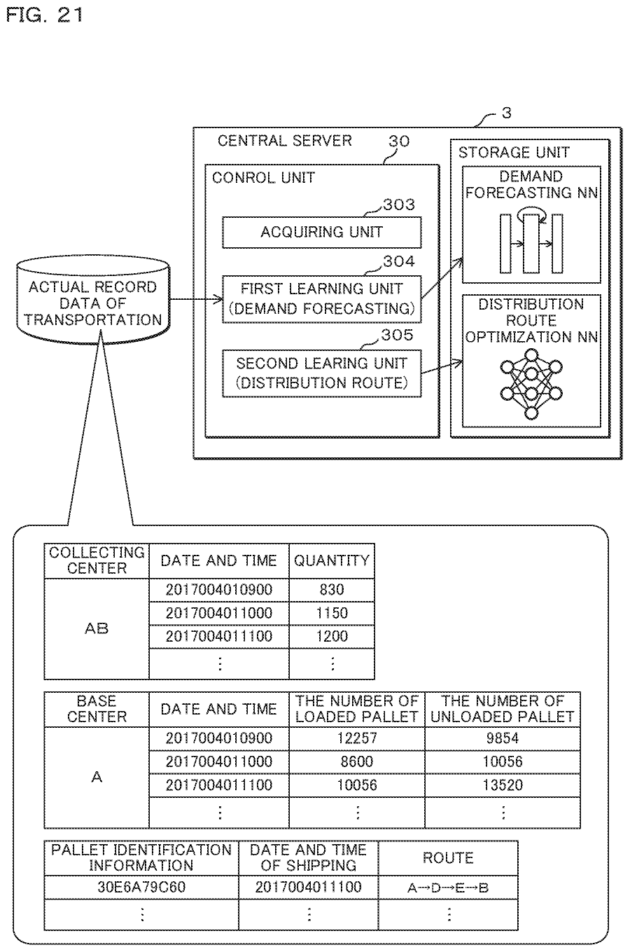

The demand forecasting and the optimization is more preferably performed using technology such as deep learning or machine learning on the basis of the learning program 32P on the basis of past transportation data. FIG. 21 is a functional block diagram related to the demand forecasting and the distribution route optimization in the central server 3.

First, the central server 3 records past actual record data in the logistics DB 310, an external storage apparatus, or the internal storage unit 31. The actual record data includes the number of collected pallets P in which the articles are loaded for each identification information of the collected collecting center 5 in accordance with a date and a time zone. The actual record data includes data in which the dispatching date and time of the pallet P is recorded for each base center 2 and data in which the route of each pallet P (the identification information of the passed base center 2) is recorded. The control unit 30 aggregates the actual record data as the demand forecasting, for example, every day and further associates the actual record data with environmental data indicating environmental conditions such as the weather of the day, a season, a temperature, the day of the week, a singularity, the presence or absence of event, a type of event, or the traffic information. The actual record data is counted with the environmental conditions. For example, at every season or every month, the average number of collections is counted for each base center 2 in accordance with temperature. The counting may be performed for each time zone, for example, hourly. Accordingly, the number of collections on Sunday in which the temperature in spring was 25 degrees can be counted such that an average number is x over the past five years.

The control unit 30 of the central server 3 functions as an acquiring unit 303 that acquires data from the recorded past actual record data, a first learning unit 304 that executes a learning process related to the demand forecasting on the acquired data, and a second learning unit 305 that executes the learning process on the distribution route. The acquiring unit 303 extracts learning target data from the actual record data in accordance with the conditions, and generates the learning data, in this case, for example, the number of shipments per hour for each base. The first learning unit 304 uses machine learning (for example, a recurrent neural network (RNN)) and generates demand forecasting NN including hidden layers in which the number of entered/exited (shipped) pallets per hour and the destination are used as output layers using conditions such as a date, a weather, a season, a temperature, the day of the week, singularity, or the presence or absence of events. Preferably, the demand forecasting NN is generated for each base. The machine learning is not limited to the RNN but may be long short-term memory (LSTM), DBN, or the like extended from it, or a deep belief network (DBN) in which learning is performed in multiple layers may be used. Also, a convolutional neural network (CNN) may be used by extending each parameter into two-dimensional data.

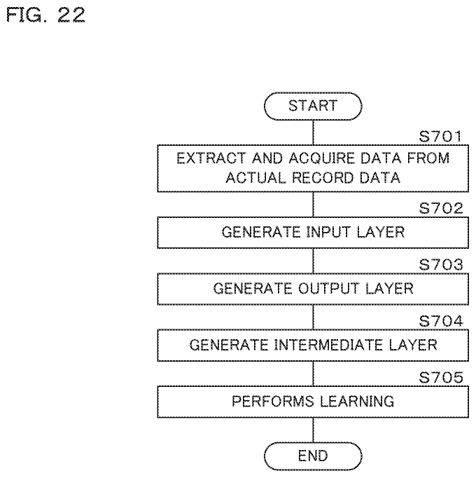

FIG. 22 is a flowchart illustrating an example of a demand forecasting NN generation processing procedure in the first learning unit 304. The control unit 30 repeatedly executes the following process for each base as the acquiring unit 303 and the first learning unit 304, for example, a predetermined number of days before the ticket sales are accepted.

As the acquiring unit 303, the control unit 30 extracts and acquires the actual record data along with the environmental data (the weather, the season, the temperature, the day of the week, or the like) hourly for each base (step S701).

Then, the control unit 30 generates an input layer as the first learning unit 304 for the data acquired in step S701 (step S702). Then, the control unit 30 generates an output layer of the number of pallets per hour, for example, as the first learning unit 304 (step S703).

As the first learning unit 304, the control unit 30 initially generates an intermediate layer including a hidden layer having a predetermined number of layers and nodes (step S704). The control unit 30 performs learning (supervised learning) of various types of parameters in the intermediate layer using the learning data which is the actual record of the number of shipments per hour acquired by the acquiring unit 303 in step S701 as the first learning unit 304 (step S705), and ends the process.

Accordingly, when the environmental data is input, the control unit 30 can acquire the demand forecasting NN that outputs the number of shipments per hour and each destination for each base center 2. The control unit 30 obtains the demand forecasting NN for each base center 2 and stores it in the storage unit 31. As described above, when various environmental data is input on the basis of the counting, conditions such as the number of pallets per time zone in each base center 2 or the collecting center 5 and parameters in the NN that outputs each destination are obtained using the actual record data as a correct answer and stored.

Then, on the basis of the learning program 32P, the control unit 30 optimizes the distribution route for reducing a time required for each pallet P to arrive at the destination from the past actual transportation record on the basis of the environmental data and the number of pallets per time zone of each base center 2 obtained by the above process. At this time, as described above, the optimum distribution route for reducing the time required for each pallet P to arrive at the destination as a whole may be decided by deep learning using a neural network. For example, as the second learning unit 305, the control unit 30 generates the distribution route optimization NN in which a time required for each article to arrive at the destination, the quantity of pallets arrived at each destination per hour, and a required time are used as the output layer using the number of entered/exited pallets per time zone in each base center 2 or each collecting center 5 and each destination as the input layer on the basis of the data acquired from the actual record data, for example, using the CNN. The output layer may be an index indicating the efficiency in terms of environment, human resources, or energy. Further, the distribution route optimization NN may be generated by performing learning while considering the base and the NN as a node and a route, respectively.

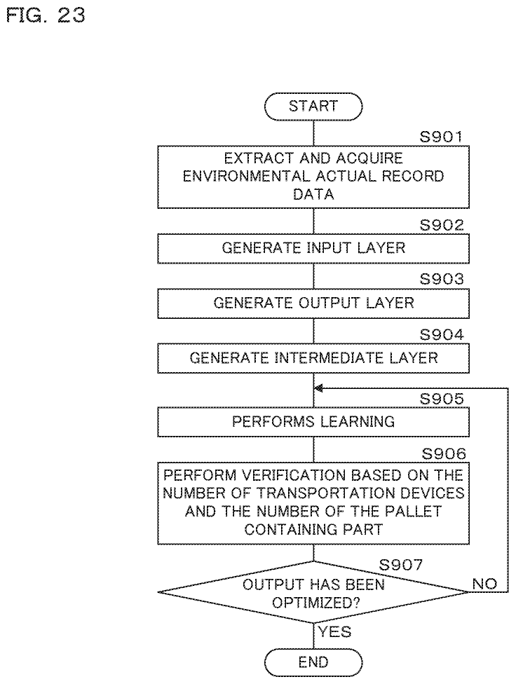

For example, the following operation is performed. FIG. 23 is a flowchart illustrating an example of a distribution route optimization NN generation processing procedure by the second learning unit 305. As the acquiring unit 303 and the second learning unit 305, the control unit 30 generates the distribution route optimization NN on the basis of the actual record data, and obtains the prediction of the optimum distribution route of each package, for example, in a case in which a prediction value of the number of entered/exited pallets P of each base center 2 per time zone and the environmental data are input before the ticket sales. It is desirable to continuously update the distribution route optimization NN at intervals of predetermined periods such as daily so that the distribution route can be predicted more accurately from the actual distribution route, the information such as the required time, and the environmental data of each day, and the parameters are optimized.

First, as the acquiring unit 303, the control unit 30 extracts and acquires the number of entered/exited (or shipped) pallets of each base center 2 per time zone and the environmental data from the actual record data indicating the past actual transportation record (step S901).

As the second learning unit 305, the control unit 30 generates the input layer from the acquired data (step S902). As the second learning unit 305, the control unit 30 generates the output layer such as the required time (step S903). Then, the control unit 30 generates the intermediate layer including the hidden layer using the learning data which is the actual record of the required time (the required time of each article) acquired in advance by the acquiring unit 303 (step S904). As the second learning unit 305, the control unit 30 learns various types of parameters in the intermediate layer including the hidden layer (step S905).

In step S904, as the second learning unit 305, the control unit 30 performs verification of applying a limitation to a weight between nodes on the basis of the number of transportation devices between bases, an upper limit of the pallet containing part, or the like during learning of a parameter for minimizing an error between the required time and the actual record (step S906). As the second learning unit 305, the control unit 30 evaluates whether or not the output has been optimized (whether or not conditions such as a minimum error, a minimum index value, and a minimum required time are satisfied) (step S907), and when it is evaluated that the output has not been optimized (S907: NO), the control unit 30 causes the process to return to step S905, and repeats the verification and the learning. In a case in which it is determined that the output has not been optimized in S907 (S907: YES), the control unit 30 ends the process. The control unit 30 may generate the intermediate layer again, for example, by causing the process to return to step S904 and changing the number of nodes or the like.

Accordingly, if the prediction value of the number of entered/exited pallets of each base and the environmental data are input, the distribution route optimization NN from which the optimal solution candidate of the distribution route is obtained is obtained. The control unit 30 provisionally decides an allocation of the predicted optimal distribution route of each package for the predicted distribution route optimization NN using the prediction number of the number of entered/exited pallets of each base per time zone obtained from the demand forecasting NN and the environmental data as the input.

Further, the control unit 30 derives an operation plan of the transportation device 1 on the basis of the number of pallets of each base center 2 per time zone in the actual transportation record on the basis of the learning program 32P. The operation plan may be obtained from the weight between base nodes in the distribution route optimization NN. It may also be derived as follows.

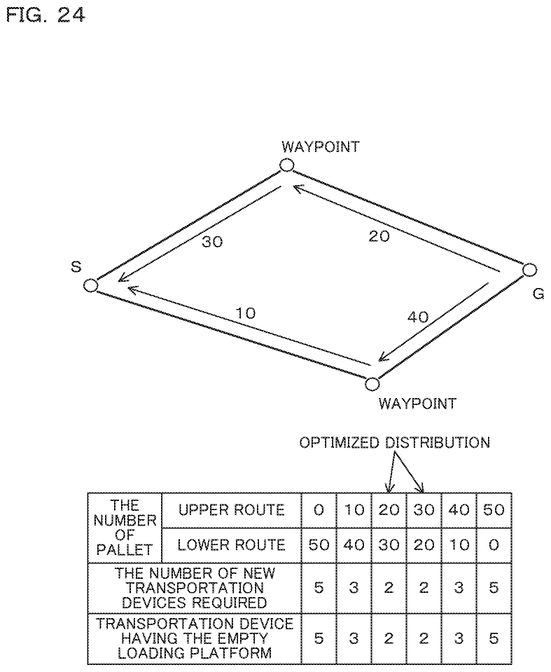

FIG. 24 is a schematic diagram illustrating an operation plan optimization process. To derive the operation plan, first, the transportation device 1 is caused to exist in each base center 2 as an initial value for each time zone, and the transportation device 1 is allocated to the route between base facilities. Each of the device information identifying the transportation device 1 and the container identification information of the container C loaded in the transportation device 1 is associated with the containing part identification information of the pallet containing part, and the number of pallet containing parts of each transportation device 1 or each container C can be specified. The control unit 30 distributes the number of pallets that can be distributed for each route, and obtains the arrangement and the transportation route of the transportation device 1 for minimizing the number of transportation devices 1 and the number of empty containing parts. The distribution of the transportation device 1 that can be relayed efficiently is obtain in order from a route of a part becoming a bottleneck.

Further, the control unit 30 performs the demand forecasting of the day serving as the ticket sales target. The number of pallets in each base center 2 or each collecting center 5 can be output by acquiring the season, the predicted temperature, the predicted traffic volume, or the like from an external service and inputting the environmental data to the demand forecasting NN. Using the number of pallets obtained by the demand forecasting and the destination thereof, the operation plan of each package is obtained using the distribution route optimization NN. The operation plan is optimized so that a minimum time required for each pallet to arrive at the destination, the number of empty pallet containing parts, and the traveling distance of each transportation device 1 are minimized using the distribution of the transportation device 1 derived from the actual record data as the initial value.

In the example illustrated in FIG. 24, for 50 pallets P, there may be two distribution routes passing through different bases from the base center 2 (indicated by S in FIG. 24) which is the dispatching point to the base center 2 (indicated by G in FIG. 24) which is the destination. A plurality of transportation devices 1 capable of containing 10 pallet Ps are assumed to exist in the base center 2 which is the dispatching point. In an upper route, there are three transportation devices 1 carrying 30 pallets P from the waypoint to the dispatching point S, and there are two transportation devices carrying 20 pallets P from the destination point to the waypoint. In a lower route, there is one transportation device 1 carrying 10 pallets P from the waypoint to the dispatching point S, and there are four transportation devices 1 carrying 40 pallets P from the destination point to the waypoint. If all 50 pallets P are desired to be transported in the lower route, a total of five transportation devices 1, that is, five new the transportation devices 1 are necessary to the waypoint, and one transportation device 1 is necessary from the waypoint to the destination point. In this case, it is a condition that all the transportation devices 1 reciprocate between the base centers 2. In this case, as illustrated in FIG. 24, 20 pallets P are transported through the upper route and 30 pallets P are transported through the lower route, and thus the number of transportation devices 1 having the empty loading platform or the empty container C can be minimized.

The control unit 30 sets the number of tickets (the number of the pallet containing parts) that can be sold in each base center 2 or the collecting center 5 for each time zone on the basis of the optimized distribution and stores this in the storage unit 31. Preferably, the control unit 30 receives the sales of the ticket on the basis of the received dispatching point and the destination point on the basis of the number of tickets stored in the storage unit 31 for each time zone every day in each base center 2 or the collecting center 5 with the process of the sales accepting unit 302 (FIGS. 19 and 20).

The number of shipped pallets per time zone in each base is decided by the tickets sold here. On the basis of this, it is desirable for the control unit 30 to sequentially review the learning result (the demand forecasting NN and the distribution route optimization NN) as the first learning unit 304 and the second learning unit 305. Further, it is desirable to revise and optimize the decision of the distribution route and the destination illustrated in the flowchart in FIG. 18 by sequentially performing the optimization again with the learning process using the NN. Further, it is desirable to issue a trigger to each base center 2 and perform a process of distributing them when the base center 2 is biased to the number of pallets or when a handling range is exceeded. With the sales of the ticket, the loading platform of the transportation device 1 or the container C that has been assigned an address is shared in units of the pallet containing parts. Accordingly, if the transportation device 1 is an example of a large truck, the cost can be reduced by one twenty fourth using the two-stage loading platform. Also, since the sharing sales for each pallet containing part is accepted by the ticket, a consignor can compare and review the transportation conditions and select the transportation route, for example, as illustrated in the screen of FIG. 19 without leaving the transportation conditions up to transportation business operators. As described above, the consignor can secure a shearing area by her/himself.

In the optimization process, the distribution of the empty pallet P itself after the article is extracted from the pallet P arriving at the destination also has to be considered. It is desirable that the pallet identification information of the unloaded pallet P be included in the optimization process. Of course, it is desirable that the pallet P arriving at the destination be loaded with other articles and distributed immediately.

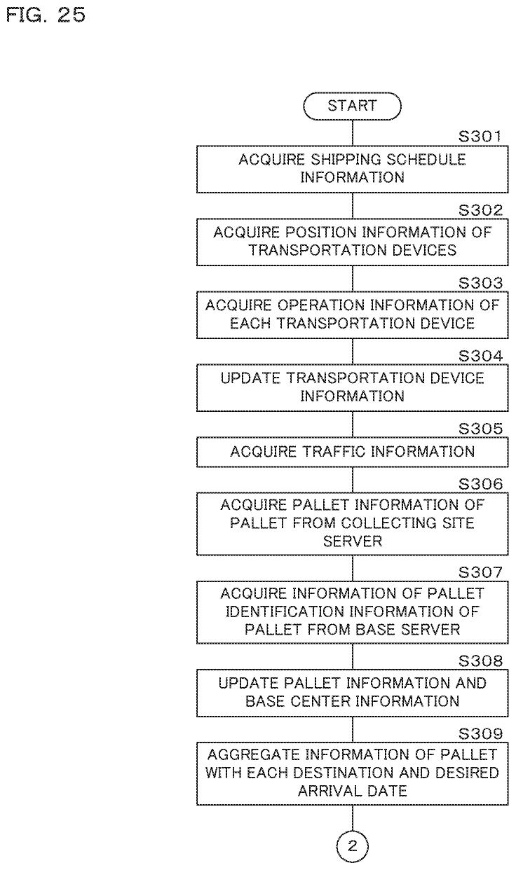

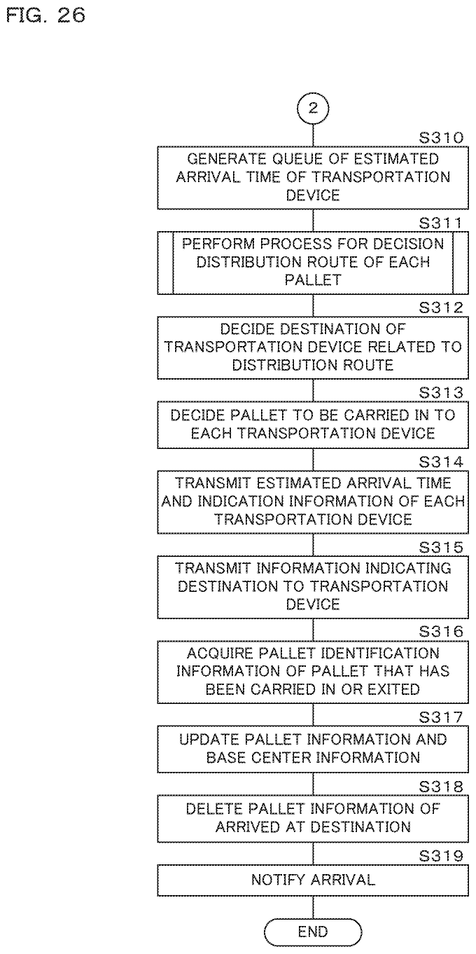

The control unit 30 of the central server 3 may decide the distribution route of each pallet P, the base center 2 through which the transportation device 1 is to pass through, and the desired base center 2 in the following processing procedure. Flowcharts in FIGS. 25 and 26 to be described below are flowcharts illustrating another example of the processing procedure by the control unit 30 of the central server 3.

The control unit 30 of the central server 3 acquires the shipping schedule information of the pallet P (article) (step S301). The shipping schedule information is information obtained by registering the shipping schedule in the logistics system 100 in the present embodiment by an operator of an organization to which each producer or a plurality of producers belong. For example, the shipping schedule is registered by receiving an input of information of a package scheduled to be shipped such as a shipping schedule date, an item, the number of shipments, the consignee, the consignee address, and the desired arrival date and time via the web page provided by the web server capable of communicating with the central server 3. The web server transmits the received information to the central server 3, and the central server 3 receives the information and stores it in the logistics DB 310 as shipping schedule information. At this time, it is desirable for the control unit 30 of the central server 3 to collate the consignee address for each desired arrival date and time. Similarly, the control unit 30 may calculate the number of packages to arrive at the same base center 2 so as to correspond to the desired arrival date and time.

Then, the control unit 30 sequentially acquires the position information from the communication device (such as an in-vehicle device) installed in the transportation device 1 or the mobile terminal apparatus carried by the driver via the carrier network N2 (step S302). Further, the control unit 30 acquires the operation information of each transportation device 1 from the communication device or the mobile terminal apparatus (step S303). The operation information acquired in step S303 includes, for example, the destination of each transportation device 1 and other information that can be received from the driver (a drivable time or the like). The control unit 30 updates the transportation device information 311 with the acquired position information and the operation information (step S304). Further, the control unit 30 acquires the traffic information from an external server via the network N (step S305). The traffic information includes travel time information, traffic jam information, delay information, construction section information, or the like.

The control unit 30 acquires the pallet information of the pallet P in which the crop F is placed from the collecting site server 51 in each place (step S306), and acquires information of the pallet identification information of the pallet that exists in the material handling system 20 of the base center 2 from the base server 21 in each place (step S307). In step S307, the control unit 30 acquires the entered pallet information which is loaded in the base center 2 and is on standby before transportation, the exited pallet information, the capacity of the buffer shelf, and information of the pallet P being stored. The control unit 30 updates the pallet information 312 and the base center information 313 with the pallet identification information acquired in steps S306 and S307 (step S308). For each base center 2, the control unit 30 aggregates the information of the pallet P with the base center 2 of each destination and the desired arrival date and time corresponding to each pallet P on the basis of the pallet identification information of the pallet P to be transported from the base center 2 (step S309).

On the basis of the current position of the transportation device 1, the control unit 30 generates a queue of the estimated arrival time of the transportation device 1 heading for any one base center 2 (step S310). On the basis of the identification information of the transportation device 1 in the queue and the pallet identification information, the current position, and the destination of all the pallets P (provisionally stored in the collecting site server 51) received by the logistics system 100, the control unit 30 decides the distribution route of each pallet P (the base center 2 to pass and one or more transportation device 1 to transport) in combination with the identification information and the containing part identification information of transportation device 1 (step S311). At this time, the control unit 30 decides the destination of the transportation device 1 related to the distribution route under a predetermined condition (step S312). As described above, the predetermined condition is a condition that a single continuous operation in which the transportation device 1 can return to the departure point after one round trip within a working time of one day of the driver is four hours at the longest from the departure point. The distribution route decision process will be described later.

On the basis of the decided distribution route, the control unit 30 decides the pallet P to be carried in to the transportation device 1 entered the base center 2 (step S313). On the basis of the distribution route decided in step S311, the control unit 30 associates the base server 21 with the queue of the estimated arrival time generated in step S310 and the pallet identification information of the pallet P, and transmits the pallet information (weight or the like) of the pallet P and instruction instructing the combination of the vehicle identification information and the containing part identification information of the pallet containing part to which the pallet P is carried in (step S314). In the base center 2 of the transmission destination, the carrying-in preparation by the sorter 203 is started on the basis of the queue of the estimated arrival time and the instruction each time.

Then, on the basis of the decision in step S312, the control unit 30 transmits information indicating the destination of the transportation device 1 to the communication device of the transportation device 1 or the mobile terminal apparatus (step S315). In the communication device or the mobile terminal apparatus, when the information indicating the destination is received, it is desirable to notify the driver of the destination using the navigation program. As the driver confirms the destination, the operation information including the destination, the estimated arrival time, or the like is transmitted again from the communication device or the mobile terminal apparatus at this point.

Then, the control unit 30 acquires the pallet identification information (the exited pallet information) of the pallet P that has been carried in the transportation device 1, the pallet P has been an exited pallet, from the base server 21 in each place (step S316). The control unit 30 updates the transportation device information 311, the pallet information 312, and the base center information 313 of the logistics DB 310 with the acquired information (step S317).

The control unit 30 receives the pallet information of the pallet P arriving at the destination from the collecting site server 51 of the destination collecting center 5, updates the logistics DB 310, and deletes the information of the pallet arriving at the destination (step S318). The control unit 30 notifies the collecting site server 51 of the sender of the arrival (step S319) and ends the process. The control unit 30 may perform the learning process for obtaining the optimal solution on the basis of the information of the transit point of each pallet P of the day on the basis of the learning program 32P through a batch process at the end of the day.

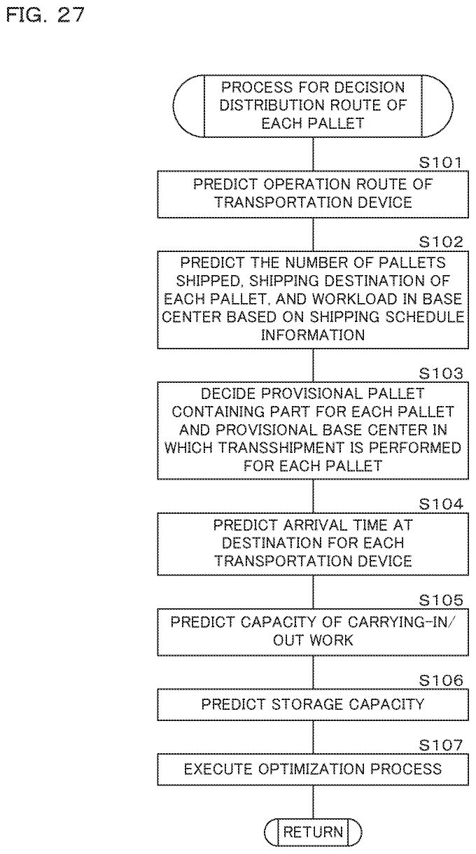

An example of the distribution route decision process in step S311 will be described. FIG. 27 is a flowchart illustrating an example of the distribution route decision processing procedure. The control unit 30 may execute the following process procedure on the basis of the optimization program 31P.

The control unit 30 generates the operation plan of the transportation device 1 at the day on the basis of the number of transportation devices 1 planned to be used at the day and the position information and the operation information of each transportation device 1 (step S101). At this time, the operation plan of each transportation device 1 is generated by predicting the route so that a predetermined condition (for example, a condition that a single continuous operation in which the transportation device 1 can return to the departure point after one round trip within a working time of one day of the driver is four hours at the longest from the departure point). In step S101, the control unit 30 uses the traffic information acquired in step S305.

The control unit 30 predicts the number of pallets P shipped (collected in the collecting center 5), the transport range (shipping destination) of each pallet P, and a workload in the base center 2 based on it on the basis of the shipping schedule information acquired in step S301 and the learning data to be described later (step S102).

The control unit 30 provisionally decides the pallet containing part (the containing part identification information) which is the containing destination in the transportation device 1 that transports each pallet P and the base center 2 in which transshipment is performed for each pallet P on the basis of the desired arrival date and time of each article (the pallet P) scheduled to be shipped on the day (step S103).

The control unit 30 predicts the arrival time at the base center 2 which is the destination for each transportation device 1 on the basis of the operation plan and the position information of the transportation device 1 and the traffic information that are updated at each time point with the transportation device information 311 (step S104).

Then, the control unit 30 predicts the capacity of the carrying-in/out work in the material handling system 20 of each base center 2 (step S105). In step S105, the control unit 30 predicts the a-out (dropping-off) standby time and a carrying-in standby time for each transportation device 1 on the basis of the arrival time of the transportation device 1 arriving at each base center 2 and the estimated arrival time of the transportation device 1 scheduled to arrive.

Then, the control unit 30 predicts the storage capacity of the pallet P in the material handling system 20 including the buffer shelf of each base center 2 (step S106). The control unit 30 predicts the number of pellets P stored in the base center at each time point on the basis of the number of pallets P existing in the base center 2 (the pallet information of the entered pallet, the carrying-out apparatus 201, and the carrying-in apparatus 204) and the estimated arrival time of the transportation device 1.

The control unit 30 executes the optimization process on the basis of the transportation device 1 and the transshipment base provisionally decided in step S103 (step S107). In the optimization process of step S107, first, the control unit 30 extracts the pallet P for which the pallet containing part in the transportation device 1 is unable to be provisionally decided. In a case in which the estimated arrival time based on the provisionally decided pallet containing part, the work capacity in the transshipment base, and the operation plan of the transportation device 1 after transshipment is delayed from the desired arrival date and time of the article placed on the pallet P, the control unit 30 extracts the pallet P. Further, if the storage capacity is exceeded, the pallet P which is unable to be stored is extracted. Further, the control unit 30 calculates a total loading weight and the operation time of the pallet P for each transportation device 1 on the basis of the pallet information of the pallet P in which the pallet containing part is able to be provisionally decided. The control unit 30 performs exchange so that the total loading weight is appropriate between the transportation devices 1 to the same destination (the base center 2), and recalculates the operation time. The control unit 30 decides the pallet containing part to which each pallet P is to be carried in on the basis of its weight. For example, the control unit 30 associates a relatively heavy pallet P (the pallet P exceeding the average weight in the same transportation device 1) among the decided pallets P with a pallet containing part in a lower stage of the pallet frame 11. The control unit 30 associates the relatively heavy pallet P with the pallet containing part in the pallet frame 11 near the front of the track. Then, the extracted pallet P is associated with the empty pallet containing part of the transportation device 1 heading for the appropriate destination on the basis of the operation plan of each transportation device 1 until it reaches the destination.

In the optimization process of step S107, the control unit 30 may further calculate the number of entries and the number of exits per hour in units of the transportation devices 1 and in units of the pallets P for each transport center 1. Then, the number of pallet storages per hour is calculated. In the optimization process, it is desirable to decide the route with reference to the traffic information that can be acquired at each time point. It is also possible to collate a pattern optimized in the past. In a case in which it can be determined that the pallet P arrives at the final base center 2 before the desired arrival date and time on the basis of the provisionally decided transportation device 1 and the transshipment base, the control unit 30 transitions from the provisional decision to decision, and in a case in which it is determined that the pallet P is unable to arrive, the control unit 30 regards it as the pallet P which is unable to be provisionally decided and executes the process again. The control unit 30 repeats the optimization calculation until it is determined that there is no problem with all items (the desired arrival date and time, the optimum total loading weight, the storage capacity within a possible range, or the like). Since these optimization processes are performed sequentially, it is not necessary to follow the distribution route which is provisionally decided, and it is desirable to decide the most efficient route with reference back to the latest traffic information or the like.

It is desirable that the processing procedure illustrated in the flowchart in FIG. 27 be executed as the re-decision of the distribution route in accordance with a situation that changes every moment with a relatively short cycle such as once every 10 minutes. In a case in which there is a pallet P in which the optimal distribution route is unable to be decided even if the optimization process is executed more than a predetermined number of times in the process procedure illustrated in the flowchart in FIG. 27, it is desirable for the control unit 30 to give a notification to the administrator on the basis of the contact information stored in association with administrator identification information. The administrator who has received the notification re-decides the route of the pallet P or takes measures of increasing the number of transportation devices 1 scheduled to be used.

The control unit 30 of the central server 3 updates the logistics DB 310 by repeating the processing procedure illustrated as an example in the flowchart in FIGS. 25 to 27 and simultaneously performing a part of the processing procedure in parallel. As described above, with the central control from the central server 3, it is possible to obtain the optimal transit point of each pallet P and the optimal solution of the transportation device 1 and execute the transportation corresponding thereto. Each instruction from the central server 3 to the base server 21 may be given in response to an inquiry from the base server 21.

In the logistics system of the related art in Japan, a system in which a plurality of base centers 2 disclosed in the present embodiment are installed, and the packages are transported while relaying between bases from a base in a place where the packages are collected to a base nearest to the consignee is regarded as being inappropriate to maintain the promptness and the certainty. In the related art, a method of transporting the article by continuously operating one carrier vehicle from a collection location to the base nearest to the consignee is regarded as being most efficient. In other words, the transportation device 1 is leased in a door-to-door manner from the sender to the destination when one article is transported. Accordingly, the logistics speed has been maintained. However, in the transportation method, there are cases in which the truck used as the carrier vehicle has poor transport efficiency since some articles are loaded in the loading platform at the time of outward, but it is waiting until the articles are collected or it is empty at the time of returning. For example, in a case in which the article is transported to a destination that can be reached in one day under the condition that the continuous operation time of the day is eight hours and the upper limit is 26 days a month, the operating rate of the carrier vehicle is 28%=(8 hours/24 hours)×(26 days/31 days). Even if the loading ratio of outward and returning is 70% in which the current actual vehicle average ratio is applied, the operation efficiency is about 14% obtained by multiplying the operation rate by the loading ratio (=28%×70% (row)×70% (return)). In a case in which the loading ratio of returning further decreases, the operation efficiency is about 10% (=28%×70% (row)×50% (return)).

On the other hand, in the logistics system 100 in the present embodiment, the operation at the upper limit of the continuous operation time of 8 hours is not performed, and thus it is possible to take a sufficient break and repeat the round trip of the distance of 3 to 4 hours twice. In this case, the operation rate of the carrier vehicle increases to 56%=(maximum 4 hours× 4/24 hours)×(26 days/31 days). Even if the loading ratio is 70% in which the current actual vehicle average ratio is applied, the operation efficiency is about 28% (=56%×70% (row)×70% (return)). Since the loading ratio of returning can be expected to increase sufficiently, the operation efficiency increases to about 35% (=56%×70% (row)×90% (return)). Long distance driving and a lodging cost are also unnecessary, and thus an average profit can be expected to increase more than five times.

As described above, in the logistics system 100 in the present embodiment, an expressway network is regarded as the line in the material handling system, and the distribution route to the destination is optimized by collating each article with the base (destination) nearest to the consignee. Then, it is transported between via transit points in the distribution route by a large truck traveling on the expressway network. Accordingly, the transport efficiency is dramatically improved, and the efficiency of regional delivery from the base center to the consignee is also improved because it is collated by the consignee. It can be expected that the delivery fee is also dramatically reduced as the delivery efficiency is improved. The organization that operates the expressway network as the line as a whole is required to be a chain-type organization which is deployed nationwide. The transportation device 1 can be realized by making a contract with this organization. Since the transportation device 1 only has to perform a round trip between bases, it can dramatically improve the working environment while improving the time efficiency. For example, since it is possible to return to the departure point within a day by a round trip, it is possible to prevent the harsh labor environments in which the long-distance truck drivers can return home only for a few days in a week, and the number of drivers can be expected to increase.

Moreover, in the logistics system 100, classification in which the articles (pallets) to be transported are classified for each producer group (manufacturer), that is, only articles produced (manufactured) by the same group can be placed in one vehicle is not performed. Therefore, the transportation device 1 can participate in the logistics system 100 regardless of whether the transportation device 1 belongs to a certain trader. Further, it is also possible to realize one-day transportation or transportation within the day, and it is possible to suppress the decrease in speed. Further, since the distribution routes can be specified individually for each pallet P, it is possible to control the quality damage or amortization.

The disclosed embodiments are to be considered as being illustrative and not restrictive in all respects. The scope of the present invention is described not by the above description but by claims set forth below and is intended to include all modifications within the meaning and the scope equivalent to claims set forth below.

1-12. (canceled)

13. A logistics system, comprising:
a plurality of pallets for logistics assigned with pallet identification information;
a plurality of base facilities accepting an entry of a transportation device that transports the plurality of pallets, carrying the pallet out of the transportation device, carrying the pallet in the transportation device, and an exit of the transportation device after the carrying in;
a plurality of base apparatuses, each of the plurality of base apparatuses being corresponding to one of the plurality of base facilities, that instructs, to the corresponding base facilities, a pallet to be carried out of the transportation device in the base facilities and a pallet to be carried in the transportation device; and
a logistics control apparatus that decides a distribution route of each pallet and a plan of the base facilities as a waypoint and a destination of the transportation device on the basis of position information of the transportation device and pallet identification information of each pallet,
wherein the logistics control apparatus re-decides, at optional times, the distribution route of each pallet and the base facility as a waypoint and as a destination of the transportation device for a pallet provisionally carried in the transportation device, on the basis of position information of the transportation device at the optional times and the pallet identification information of the plurality of pallets which are loaded in the transportation device or are located at base facilities, and transmits the pallet identification information to the base apparatus of the decided base facility as the waypoint or the destination, the pallet identification information identifying a pallet to be carried out at the decided base facility and a pallet to be carried in at the decided base facility.

14. The logistics system according to claim 13, wherein
the transportation device loads a container containing the plurality of pallets.

15. The logistics system according to claim 13, wherein
the logistics control apparatus instructs, to the transportation device, the base facility of the waypoint or the destination on the basis of a decision result by the route deciding unit after each transportation device starts transportation on the basis of the planning.

16. The logistics system according to claim 13, wherein
the base facility includes
an carrying-out apparatus that carries out a pallet on which an article is placed from a loading platform of the transportation device,
a sorter that sorts and transmits a plurality of pallets including the carried-out pallet, and
a carrying-in apparatus that carries in the pallet transmitted from the sorter to the loading platform of the transportation device or a container loaded on the transportation device, and
the base apparatus receives an instruction including identification information of a transportation device of a carrying-in destination of each pallet or the container based on the distribution route decided by the route deciding unit of the logistics control apparatus, and outputs instruction including a correspondence with the pallet identification information of the pallet to be carried in the loading platform of the transportation device or the container to the sorter and the carrying-in apparatus on the basis of the received instruction.

17. The logistics system according to claim 16, wherein
the transportation device includes a loading platform provided with a frame divided into a plurality of pallet containing parts or loads a container provided with the frame,
the plurality of pallet containing parts of the frame is assigned with containing part identification information,
the base apparatus receives instruction including a correspondence of the identification information of the transport device of the carrying-in destination, the pallet identification information of the pallet to be carried in the transport device, and the containing part identification information of the pallet containing part in which each pallet is to be contained, and
the carrying-in apparatus carries a pallet into the pallet containing part corresponding to the containing part identification information included in the instruction, the pallet attached the pallet identification information included in the instruction.

18. The logistics system according to claim 17, wherein
the logistics control apparatus
decides a distribution route indicating one or more base facilities through which a target pallet is to pass on the basis of a dispatching point and a destination of target pallet,
extracts candidates of a series of containing part identification information in which the containing part identification information of the pallet containing part capable of containing the pallet at the dispatching point is associated with the containing part identification information of the pallet containing parts to pass to the destination on the basis of the decided distribution route, and
accepts sales of a ticket specifying one of the extracted candidates for the target pallet.

19. The logistics system according to claim 18, wherein
the decision of the distribution route is performed by machine learning based on past actual record data.

20. The logistics system according to claim 18, wherein
the logistics control apparatus
acquires pallet demand forecasting,
acquires an operation plan of the transportation device, and
executes an estimation process of estimating the number of tickets available for sales per each time zone for each dispatching point.

21. The logistics system according to claim 20, wherein
the demand forecasting or the estimation process is performed by machine learning based on the past actual record data.

22. A logistics system, comprising:
a plurality of pallets for logistics assigned with pallet identification information;
a plurality of transportation devices including a loading platform or loading a container provided with a frame divided into a plurality of pallet containing parts, each of the plurality of pallet containing parts containing one or more of the plurality of pallets;
a plurality of base facilities that accept entries and exits of the plurality of transportation devices;
a plurality of base apparatuses that output instruction, to the base facilities, instructing a pallet to be carried out from the frame of the loading platform the transportation device or the container to enter the plurality of base facilities and a pallet to be carried in the frame; and
a logistics control apparatus, being communication-connected with the plurality of base apparatuses, decides a distribution route of each pallet, the base facilities as a waypoint or a destination of the transportation device on the basis of position information of the transportation device, the containing part identification information assigned to each pallet containing part of the frame of the transportation device, and the pallet identification information,
wherein the logistics control apparatus transmits, to the plurality of base apparatuses, containing part identification information of a pallet containing part in which a pallet to be carried out of the transportation device entered each of the plurality of base facilities and instruction including a correspondence of pallet identification information of a pallet to be carried in the transportation device and containing part identification information of a pallet containing part in which the pallet to be contained, and
the plurality of base facilities carries out the pallet from the pallet containing part of the transportation device to enter or the container, and carries in the pallet with the corresponding pallet identification information into the pallet containing part corresponding to the containing part identification information included in the instruction.

23. The logistics system according to claim 22, wherein
the logistics control apparatus
re-decides, at optional times, the distribution route of each pallet and the base facility as a waypoint and as a destination of the transportation device for a pallet provisionally carried in the transportation device or the container, on the basis of the position information of the transportation device at the optional times and the pallet identification information of the pallet which are loaded in the transportation device or are located at base facilities, and
transmits the pallet identification information of the pallet to be carried out and the pallet to be carried in, to a base apparatus of the decided base facility.

24. A logistics method performed in a logistic system including a plurality of pallets for logistics, a transportation device that transports the plurality of pallets, a logistics control apparatus that decides a transportation route of the transportation device transporting the pallet and planning of a distribution route of each pallet and a base apparatus that instructs, to the base facilities, a pallet to be carried out and a pallet to be carried in, corresponding to a plurality of base facilities being installed at a given distance, the logistics method comprising:
acquiring, by the logistics control apparatus, position information of the transportation device at optional times;
storing, by the logistics control apparatus, pallet identification information assigned to each of the plurality of pallets in association with device identification information assigned to each of the transportation devices that transport the pallet;
re-deciding, by the logistics control central apparatus, the distribution route of each pallet and the base facility as the waypoint for a pallet provisionally carried in the transportation device on the basis of the position information of the transportation device and the pallet identification information of the pallet at the optional times;
transmitting, by the logistics control apparatus, device identification information of the transportation device heading for the corresponding base facility and the pallet identification information of a pallet to be carried out from the transportation device and a pallet to be carried in the transportation device, to the base apparatus of the decided base facility; and
instructing the base facility of the waypoint to the transportation device.
